(19) United States
(12) Patent Application Publication
(10) Pub. No.: US 2025/0192677 A1
(43) Pub. Date: Jun. 12, 2025

(54) VOLTAGE CONVERTER AND OPERATING METHOD OF VOLTAGE CONVERTER

(71) Applicant: Samsung Electronics Co., Ltd., Suwon-si (KR)

(72) Inventors: HYUNGJU PARK, Suwon-si (KR); MINWOO KIM, Suwon-si (KR); JINHO NOH, Suwon-si (KR)

(21) Appl. No.: 18/663,360

(22) Filed: May 14, 2024

(30) Foreign Application Priority Data
Dec. 7, 2023 (KR) 10-2023-0176828

(51) Int. Cl. H02M 3/158

(52) U.S. Cl. CPC H02M 3/158

(57) ABSTRACT

Disclosed is a conversion device that includes a first regulator converting an input voltage of an input node into a first output voltage in a first mode and providing the first output voltage to an output node, a second regulator converting the input voltage of the input node into a second output voltage in a second mode and providing the second output voltage to the output node, a first resistor and a second resistor connected in series between the output node and a ground node, and an error amplifier receiving a feedback voltage of a node between the first resistor and the second resistor and a reference voltage, amplifying a difference between the feedback voltage and the reference voltage to generate an error voltage, providing the error voltage to the first regulator in the first mode, and providing the error voltage to the second regulator in the second mode.

### CROSS-REFERENCE TO RELATED APPLICATIONS

This application claims priority under 35 U.S.C. § 119 to Korean Patent Application No. 10-2023-0176828 filed on Dec. 7, 2023, in the Korean Intellectual Property Office, the disclosure of which is incorporated by reference herein in its entirety.

### BACKGROUND OF THE INVENTION

Embodiments of the present disclosure described herein relate to an electronic device, and more particularly, relate to a voltage converter providing various voltage conversion modes and an operating method of the voltage converter.

Electronic devices may operate based on power from outside of the electronic devices. For example, the electronic devices may convert an external power supply voltage from the outside into an internal power supply voltage and may supply the internal power supply voltage to internal components. A mobile device such as a smartphone or a smart pad may further include a battery.

When the external power supply voltage is supplied, the mobile device may convert and use the external power supply voltage into the internal power supply voltage. Also, when the external power supply voltage is supplied, the mobile device may charge the battery by using the external power supply voltage. When the external power supply voltage is not supplied, the mobile device may convert and use a battery power supply voltage into the internal power supply voltage.

The battery power supply voltage may vary depending on a charging rate of the battery. For example, as the charging rate of the battery increases, the battery power supply voltage may increase. As the charging rate of the battery decreases, the battery power supply voltage may decrease. Also, the internal power supply voltage may vary depending on a load. When the load increases, the internal power supply voltage may decrease to be lower than a target voltage level (e.g., at least transiently). When the internal power supply voltage is smaller than the target voltage level, the power-off may occur in the mobile device.

Accordingly, a device which converts the battery power supply voltage into the internal power supply voltage should be configured to convert a varying input voltage (i.e., the battery power supply voltage) into a fixed voltage (i.e., the target voltage level of the internal power supply voltage).

### SUMMARY OF THE INVENTION

Embodiments of the present disclosure provide a voltage converter capable of providing improved voltage conversion efficiency through a mode transition and reducing a ripple in the mode transition while having the reduced area and an operating method of the voltage converter.

According to an embodiment, a conversion device includes a first regulator that converts an input voltage of an input node into a first output voltage in a first mode and provides the first output voltage to an output node, a second regulator that converts the input voltage of the input node into a second output voltage in a second mode and provides the second output voltage to the output node, a first resistor and a second resistor that are connected in series between the output node and a ground node, and an error amplifier that receives a feedback voltage of a node between the first resistor and the second resistor and a reference voltage, amplifies a difference between the feedback voltage and the reference voltage to generate an error voltage, provides the error voltage to the first regulator in the first mode, and provides the error voltage to the second regulator in the second mode.

According to an embodiment, a voltage conversion device includes a first regulator that converts an input voltage of an input node into a first output voltage in a first mode and provides the first output voltage to an output node, and a second regulator that converts the input voltage of the input node into a second output voltage in a second mode and provides the second output voltage to the output node. The first regulator includes a voltage converter that is connected to the input node and the output node and includes a plurality of switches, at least one inductor, and at least one capacitor, a control circuit that generates control signals corresponding to the plurality of switches such that the input voltage of the input node is converted into the first output voltage, the first output voltage being transferred to the output node, and a power stage that controls the plurality of switches based on the control signals. In the first mode, the control circuit generates emulated duty signals based on the input voltage and the first output voltage, controls a ramp signal based on the emulated duty signals, and controls switching timings of the control signals based on an error voltage and the ramp signal.

According to an embodiment, an operating method of a voltage conversion device that includes a switching regulator and a linear regulator includes converting an input voltage into an output voltage by using the switching regulator, in a first mode, converting the input voltage into the output voltage by using the linear regulator when a transition from the first mode to a second mode is made, and presetting switching timings of the switching regulator and an error voltage while the output voltage is not provided by the switching regulator and is not provided by the linear regulator, when a transition from the second mode to the first mode is made. An error amplifier providing the error voltage is shared by the switching regulator and the linear regulator.

### BRIEF DESCRIPTION OF THE FIGURES

The above and other objects and features of the present disclosure will become apparent by describing in detail embodiments thereof with reference to the accompanying drawings.

FIG. 1 is a schematic block diagram illustrating a voltage conversion device according to an embodiment of the present disclosure.

FIG. 2 is a flowchart illustrating an example of an operating method of a voltage conversion device.

FIG. 3 is a graph illustrating an example in which a mode control circuit controls a first enable signal, a second enable signal, and a third enable signal.

FIG. 4 is a schematic block diagram illustrating a control circuit according to an embodiment of the present disclosure.

FIG. 5 is a schematic block diagram illustrating a duty calculator according to an embodiment of the present disclosure.

FIG. 6 is a graph illustrating an example of a second ramp signal, a first difference signal, and an emulated buck duty signal, according to an embodiment of the present disclosure.

FIG. 7 is a graph illustrating an example of a third ramp signal, a second difference signal, and an emulated boost duty signal, according to an embodiment of the present disclosure.

FIG. 8 is a flowchart illustrating an example of a method in which a first regulator of a voltage conversion device presets switching timings and an error voltage.

FIG. 9 is a circuit diagram illustrating an average duty controller according to an embodiment of the present disclosure.

FIG. 10 is a circuit diagram illustrating a voltage converter according to an embodiment of the present disclosure.

FIG. 11 is a flowchart illustrating an example of a method in which a first regulator converts an input voltage into an output voltage in the first mode.

FIG. 12 is a graph illustrating a first example of signals of a first regulator according to an embodiment of the present disclosure.

FIG. 13 is a circuit diagram illustrating an example in which a voltage converter controls a first switch, a second switch, a third switch, and a fourth switch in a charging interval of a buck conversion manner of a first mode.

FIG. 14 is a circuit diagram illustrating an example in which a voltage converter controls a first switch, a second switch, a third switch, and a fourth switch in a discharging interval of a buck conversion manner of a first mode.

FIG. 15 is a graph illustrating a second example of signals of a first regulator according to an embodiment of the present disclosure.

FIG. 16 is a circuit diagram illustrating an example in which a voltage converter controls a first switch, a second switch, a third switch, and a fourth switch in a charging interval of a buck-boost conversion manner of a first mode.

FIG. 17 is a circuit diagram illustrating an example in which a voltage converter controls a first switch, a second switch, a third switch, and a fourth switch in a discharging interval of a buck-buck conversion manner of a first mode.

FIG. 18 is a graph illustrating a third example of signals of a first regulator according to an embodiment of the present disclosure.

FIG. 19 is a circuit diagram illustrating an example in which a voltage converter controls a first switch, a second switch, a third switch, and a fourth switch in a charging interval of a buck conversion manner of a first mode.

FIG. 20 is a circuit diagram illustrating an example in which a voltage converter controls a first switch, a second switch, a third switch, and a fourth switch in a discharging interval of a buck conversion manner of a first mode.

FIG. 21 is a schematic block diagram illustrating a voltage conversion device according to another embodiment of the present disclosure.

FIG. 22 is a schematic block diagram illustrating a controller according to another embodiment of the present disclosure.

FIG. 23 is a block diagram illustrating an electronic device including a voltage conversion device according to an embodiment of the present disclosure.

### DETAILED DESCRIPTION

Below, embodiments of the present disclosure will be described in detail and clearly to such an extent that an ordinary one in the art can easily carry out the present disclosure.

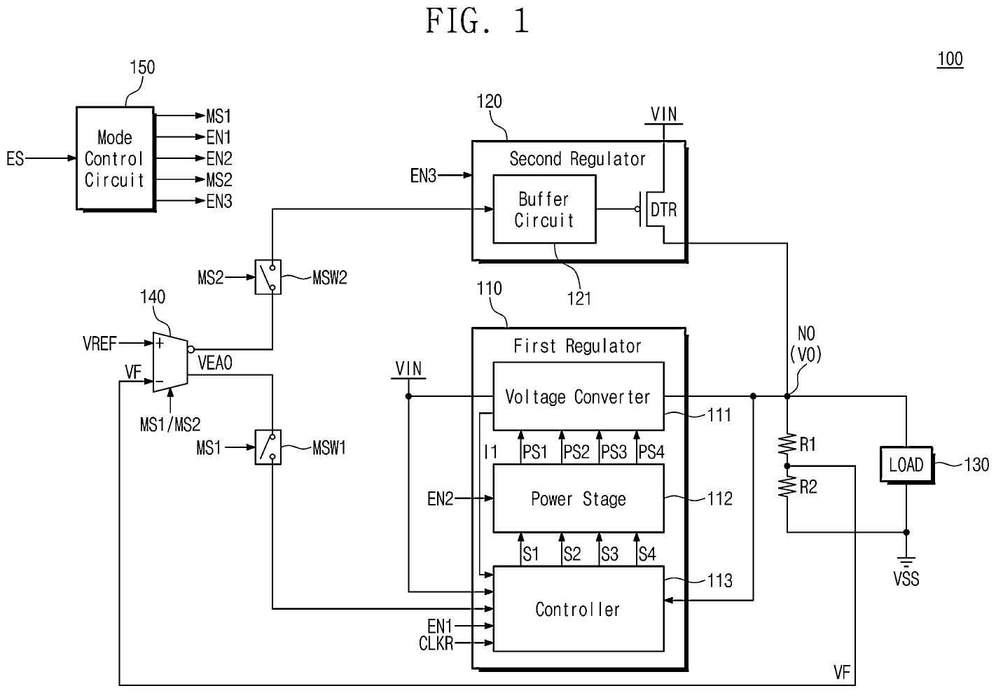

FIG. 1 illustrates a voltage conversion device 100 according to an embodiment of the present disclosure. Referring to FIG. 1, the voltage conversion device 100 may include a first regulator 110, a second regulator 120, an error amplifier 140, a mode control circuit 150, a first resistor R1, a second resistor R2, a first mode switch MSW1, and a second mode switch MSW2.

In a first mode (or a first voltage conversion mode), the first regulator 110 may convert an input voltage VIN of an input node into an output voltage VO (e.g., a first output voltage) so as to be provided to an output node NO. In a second mode (or a second voltage conversion mode), the second regulator 120 may convert the input voltage VIN of the input node into the output voltage VO (e.g., a second output voltage) so as to be provided to the output node NO. For example, the input voltage VIN which is supplied to the first regulator 110 and the second regulator 120 may be the same voltage which is provided from the same voltage source (e.g., a battery).

The first regulator 110 may include a switching regulator which performs switching voltage conversion by turning on or off switches. The first regulator 110 may include a voltage converter 111, a power stage 112, and a controller 113 (e.g., a control circuit). The voltage converter 111 may include a plurality of switches, at least one inductor, and at least one capacitor. The second regulator 120, on the other hand, may be free of (i.e., may not include) a voltage converter, a power stage, and a controller.

The power stage 112 may receive control signals including a first signal S1, a second signal S2, a third signal S3, and a fourth signal S4 from the controller 113. The power stage 112 may convert the first signal S1, the second signal S2, the third signal S3, and the fourth signal S4 into a first power signal PS1, a second power signal PS2, a third power signal PS3, and a fourth power signal PS4 for switching the plurality of switches of the voltage converter 111. The power stage 112 may switch (or turn on or off) the plurality of switches of the voltage converter 111 by providing the first power signal PS1, the second power signal PS2, the third power signal PS3, and the fourth power signal PS4 to the voltage converter 111.

For example, waveforms of the first power signal PS1, the second power signal PS2, the third power signal PS3, and the fourth power signal PS4 may be the same as waveforms of the first signal S1, the second signal S2, the third signal S3, and the fourth signal S4, respectively. Voltage amplitudes of the first power signal PS1, the second power signal PS2, the third power signal PS3, and the fourth power signal PS4 may be greater than voltage amplitudes of the first signal S1, the second signal S2, the third signal S3, and the fourth signal S4, respectively.

The power stage 112 may receive a second enable signal EN2 from the mode control circuit 150. When the second enable signal EN2 is activated, the power stage 112 may be powered on. When the second enable signal EN2 is deactivated (e.g., in the second mode), the power stage 112 may be powered off.

The controller 113 may receive the input voltage VIN and the output voltage VO. The controller 113 may extract a current flowing through an internal current path, for example, first current information I1 from an internal current path of the voltage converter 111. The controller 113 may receive an error voltage VEAO from the error amplifier 140. The controller 113 may receive a reference clock signal CLKR from an external device (i.e., a device that is external to the voltage conversion device 100).

Based on the input voltage VIN, the output voltage VO, the first current information I1, the error voltage VEAO, and the reference clock signal CLKR, the controller 113 may control the timings at which the first signal S1, the second signal S2, the third signal S3, and the fourth signal S4 are switched (or transition) such that the voltage converter 111 converts the input voltage VIN into the output voltage VO.

For example, when the level of the output voltage VO is lower than the target level, the controller 113 may control the timings at which the first signal S1, the second signal S2, the third signal S3, and the fourth signal S4 are switched (or transition) such that the level of the output voltage VO increases. When the level of the output voltage VO is higher than the target level, the controller 113 may control the timings at which the first signal S1, the second signal S2, the third signal S3, and the fourth signal S4 are switched (or transition) such that the level of the output voltage VO decreases.

The controller 113 may receive a first enable signal EN1 from the mode control circuit 150. When the first enable signal EN1 is activated, the controller 113 may be powered on. When the first enable signal EN1 is deactivated (e.g., in the second mode), the controller 113 may be powered off.

The second regulator 120 may include a linear regulator which performs linear voltage conversion. The second regulator 120 may include a driving transistor DTR and a buffer circuit 121. The driving transistor DTR may include a gate receiving an output of the buffer circuit 121, a first terminal to which the input voltage VIN is supplied, and a second terminal connected to the output node NO. As used herein, the term “connected” refers to an electrical connection/coupling with or without an intervening element, and/or direct connection/coupling without an intervening element. The driving transistor DTR may transfer the input voltage VIN to the output node NO in response to a voltage output from the buffer circuit 121. For example, the driving transistor DTR may include a PMOS transistor.

The buffer circuit 121 may receive the error voltage VEAO from the error amplifier 140. The buffer circuit 121 may buffer the error voltage VEAO so as to be transferred to the driving transistor DTR. The buffer circuit 121 may transfer the level of the error voltage VEAO to the gate of the driving transistor DTR. For example, the buffer circuit 121 may include a voltage follower which follows the level of the error voltage VEAO.

The output node NO may be connected to a load 130. The first resistor R1 and the second resistor R2 may be connected in series between the output node NO and a ground node to which a ground voltage VSS is supplied. A voltage of a node between the first resistor R1 and the second resistor R2, for example, a feedback voltage VF may be transferred to the error amplifier 140. The error amplifier 140 may amplify a difference between a reference voltage VREF and the feedback voltage VF so as to be output as (e.g., to generate) the error voltage VEAO.

The first mode switch MSW1 may operate in response to a first mode signal MS1. When the first mode signal MS1 is activated, the first mode switch MSW1 may transfer the error voltage VEAO output from the error amplifier 140 to the first regulator 110. When the first mode signal MS1 is deactivated, the first mode switch MSW1 may block the error voltage VEAO output from the error amplifier 140 from being transferred to the first regulator 110.

The second mode switch MSW2 may operate in response to a second mode signal MS2. When the second mode signal MS2 is activated, the second mode switch MSW2 may transfer the error voltage VEAO output from the error amplifier 140 to the second regulator 120. When the second mode signal MS2 is deactivated, the second mode switch MSW2 may block the error voltage VEAO output from the error amplifier 140 from being transferred to the second regulator 120.

The error amplifier 140 may receive the reference voltage VREF as/at a positive (+) input and may receive the feedback voltage VF as/at a negative (−) input. The error amplifier 140 may receive the first mode signal MS1 or the second mode signal MS2. The error amplifier 140 may amplify a difference between the reference voltage VREF and the feedback voltage VF in response to the first mode signal MS1 or the second mode signal MS2.

For example, the error amplifier 140 may include a normal (or non-inverting) output and an inverting output. In the first mode where the first regulator 110 is powered on, the error amplifier 140 may amplify a value obtained by subtracting the level of the feedback voltage VF from the level of the reference voltage VREF so as to be output as the normal output. In the second mode where the second regulator 120 is powered on, the error amplifier 140 may amplify the value obtained by subtracting the level of the feedback voltage VF from the level of the reference voltage VREF so as to be output as the inverting output. Operating in the second mode may thus include inverting the value obtained by subtracting the level of the feedback voltage VF from the level of the reference voltage VREF, and providing the inverted value to the second mode switch MSW2.

In an embodiment, the level of the reference voltage VREF may be defined (or determined) based on a division ratio of the feedback voltage VF to the output voltage VO, which is determined by a resistance value of the first resistor R1 and a resistance value of the second resistor R2, and the target level of the output voltage VO.

When the level of the output voltage VO is lower than the target level, the feedback voltage VF may be lower than the reference voltage VREF. The first regulator 110 and the second regulator 120 are both coupled (e.g., switchably coupled by the mode switches MSW1 and MSW2, respectively) between the error amplifier 140 and the output node NO. In the first mode, when the level of the output voltage VO is lower than the target level, the error amplifier 140 may provide the error voltage VEAO of/having a positive level to the first regulator 110. As the level of the output voltage VO becomes lower than the target level, the error amplifier 140 may provide the error voltage VEAO of a higher positive level to the first regulator 110. The first regulator 110 may control the switching timings of the first signal S1, the second signal S2, the third signal S3, and the fourth signal S4 such that the level of the output voltage VO increases.

In the second mode, when the level of the output voltage VO is lower than the target level, the error amplifier 140 may provide the error voltage VEAO of a negative level to the second regulator 120. As the level of the output voltage VO becomes lower than the target level, the error amplifier 140 may provide the error voltage VEAO of/having a lower negative level to the second regulator 120. As the negative level of the error voltage VEAO becomes lower, the amount of current which the driving transistor DTR supplies to the output node NO may increase. That is, the driving transistor DTR may control the amount of current in a direction in which the output voltage VO increases.

In an embodiment, the driving transistor DTR, which supplies a current to the output node NO in the second mode, may be implemented with a PMOS transistor. Accordingly, the trend of change of the error voltage VEAO (e.g., the increase or decrease of the error voltage VEAO) and the trend (e.g., decrease or increase) of the amount of current supplied by the driving transistor DTR may be opposite.

When the level of the output voltage VO is lower than the target level, the feedback voltage VF may be higher than the reference voltage VREF. In the first mode, when the level of the output voltage VO is higher than the target level, the error amplifier 140 may provide the error voltage VEAO of/having a negative level to the first regulator 110. As the level of the output voltage VO becomes higher than the target level, the error amplifier 140 may provide the error voltage VEAO of/having a lower positive level to the first regulator 110. The first regulator 110 may control the switching timings of the first signal S1, the second signal S2, the third signal S3, and the fourth signal S4 such that the level of the output voltage VO decreases.

In the second mode, when the level of the output voltage VO is higher than the target level, the error amplifier 140 may provide the error voltage VEAO of/having a positive level to the second regulator 120. As the level of the output voltage VO becomes higher than the target level, the error amplifier 140 may provide the error voltage VEAO of/having a higher positive level to the second regulator 120. As the positive level of the error voltage VEAO becomes higher, the amount of current which the driving transistor DTR supplies to the output node NO may decrease. That is, the driving transistor DTR may control the amount of current in a direction in which the output voltage VO decreases.

The first regulator 110 and the second regulator 120 may operate based on negative feedback such that a difference between the level of the output voltage VO and the target level decreases.

The mode control circuit 150 may control a mode of the voltage conversion device 100. In the first mode, the mode control circuit 150 may activate the first mode signal MS1, the first enable signal EN1, and the second enable signal EN2 and may deactivate the second mode signal MS2 and a third enable signal EN3. In the second mode, the mode control circuit 150 may deactivate the first mode signal MS1, the first enable signal EN1, and the second enable signal EN2 and may activate the second mode signal MS2 and the third enable signal EN3. In an embodiment, the mode control circuit 150 may control the mode of the voltage conversion device 100 in response to a signal ES received from the external device.

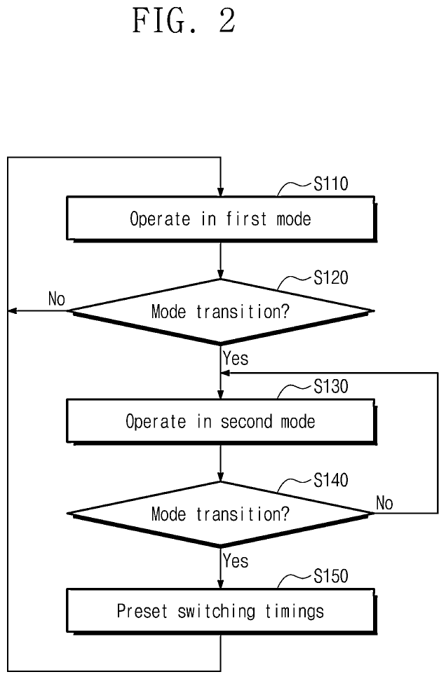

FIG. 2 illustrates an example of an operating method of the voltage conversion device 100. Referring to FIGS. 1 and 2, in operation S110, the voltage conversion device 100 may operate in the first mode. In the first mode, the first regulator 110 may convert the input voltage VIN into the output voltage VO based on a switching voltage conversion manner.

In operation S120, the voltage conversion device 100 may determine whether a mode transition is made. The mode control circuit 150 may determine whether the signal ES requesting the mode transition is received from the external device. When the signal ES requesting the mode transition is not received from the external device, the voltage conversion device 100 may continuously operate in the first mode by continuously performing operation S110.

When the signal ES requesting the mode transition is received from the external device, in operation S130, the voltage conversion device 100 may operate in the second mode. In the second mode, the second regulator 120 may convert the input voltage VIN into the output voltage VO in (e.g., based on) a linear voltage conversion manner.

In operation S140, the voltage conversion device 100 may determine whether a mode transition is made. The mode control circuit 150 may determine whether the signal ES requesting the mode transition is received from the external device. When the signal ES requesting the mode transition is not received from the external device, the voltage conversion device 100 may continuously operate in the second mode by continuously performing operation S130.

When the signal ES requesting the mode transition is received from the external device, in operation S150, the voltage conversion device 100 may preset switching timings. For example, based on the input voltage VIN, the output voltage VO, and the error voltage VEAO, the controller 113 of the first regulator 110 may preset the switching timings of the first signal S1, the second signal S2, the third signal S3, and the fourth signal S4 and may preset the level of the error voltage VEAO.

For example, the controller 113 may preset the switching timings of the first signal S1, the second signal S2, the third signal S3, and the fourth signal S4 and the level of the error voltage VEAO, so as to correspond to the current level of the output voltage VO. While the controller 113 is presetting the switching timings and the error voltage VEAO, the output voltage VO may be blocked/paused such that it is provided by neither the first regulator 110 nor the second regulator 120 to the output node NO. Afterwards, in operation S110, the voltage conversion device 100 may operate in the first mode.

According to an embodiment of the present disclosure, when the transition from the second mode to the first mode is made, the controller 113 may preset the switching timings of the first signal S1, the second signal S2, the third signal S3, and the fourth signal S4 and the level of the error voltage VEAO. When the voltage conversion device 100 enters the first mode, the switching timings of the first signal S1, the second signal S2, the third signal S3, and the fourth signal S4 and the level of the error voltage VEAO may correspond to the current level of the output voltage VO. Accordingly, a ripple may be suppressed from occurring at the level of the output voltage VO.

In an embodiment, the description is given as one signal ES requests the mode transition. A voltage level of the signal ES may determine which mode is requested. For example, the first mode may be requested when the signal ES has the high level (or low level), and the second mode may be requested when the signal ES has the low level (or high level).

Alternatively, as the signal ES toggles once, the signal ES may request to enter a mode different from a current mode, irrespective of a voltage level of the signal ES. For example, when the signal ES toggles once, the voltage conversion device 100 may enter the second mode from the first mode, and when the signal ES toggles again once, the voltage conversion device 100 may enter the first mode from the second mode.

As another example, the signal ES may include one signal associated with the first mode and another signal associated with the second mode. As the signal ES has a specific level or toggles at least once, the signal ES may request to enter a relevant mode.

In an embodiment, when a device including the voltage conversion device 100 is powered off, the voltage conversion device 100 may terminate the operation of FIG. 2 and may be powered off.

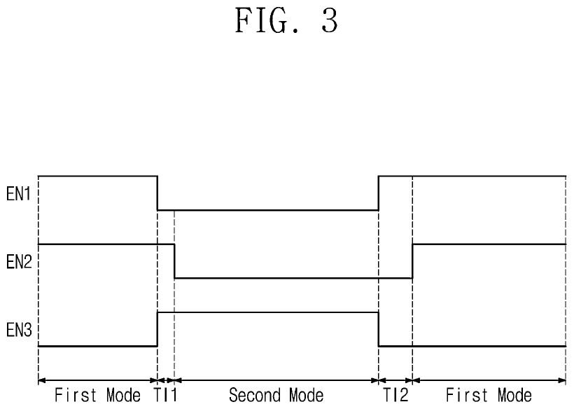

FIG. 3 illustrates an example in which the mode control circuit 150 controls the first enable signal EN1, the second enable signal EN2, and the third enable signal EN3. Referring to FIGS. 1 and 3, in the first mode, the mode control circuit 150 may power on the first regulator 110 by activating/increasing the first enable signal EN1 and the second enable signal EN2 at/to the high level. Also, the mode control circuit 150 may power off the second regulator 120 by deactivating/decreasing the third enable signal EN3 at/to the low level.

When a request to enter the second mode from the first mode is made, in a first time interval TI1, the mode control circuit 150 may power off the controller 113 by deactivating/decreasing the first enable signal EN1 at/to the low level. The mode control circuit 150 may power on the second regulator 120 by activating/increasing the third enable signal EN3 at/to the high level. While the second regulator 120 is initialized, the mode control circuit 150 may maintain the power-on state of the power stage 112 by maintaining the second enable signal EN2 at the high level.

The power stage 112 may transmit outputs of the first power signal PS1, the second power signal PS2, the third power signal PS3, and the fourth power signal PS4 in a high impedance (High-Z) state. During the first time interval TI1, a preparation operation of the second regulator 120 such as charging of a capacitor (not illustrated) for stabilizing the operation of the second regulator 120 may be performed.

After the first time interval TI1, in the second mode, the mode control circuit 150 may power off the power stage 112 by deactivating/decreasing the second enable signal EN2 at/to the low level.

When a request to enter the first mode from the second mode is made, in a second time interval TI2, the mode control circuit 150 may power off the second regulator 120 by deactivating/decreasing the third enable signal EN3 at/to the low level. The mode control circuit 150 may power on the controller 113 by activating the first enable signal EN1 to the high level. The controller 113 may preset the switching timings of the first signal S1, the second signal S2, the third signal S3, and the fourth signal S4 and the level of the error voltage VEAO so as to correspond to the current level of the output voltage VO. In some embodiments, the controller 113 may preset the switching timings and the error voltage VEAO based on negative feedback. The mode control circuit 150 may maintain the power-off state of the power stage 112 (e.g., while the controller 113 presets the error voltage VEAO and the switching timings) by maintaining the second enable signal EN2 at the low level. The voltage converter 111 may also maintain a power-off state while the controller 113 presets the error voltage VEAO and the switching timings.

While the controller 113 presets the switching timings of the first signal S1, the second signal S2, the third signal S3, and the fourth signal S4 and the level of the error voltage VEAO so as to correspond to the current level of the output voltage VO, the power stage 112 may not generate the first power signal PS1, the second power signal PS2, the third power signal PS3, and the fourth power signal PS4. Accordingly, the change in the output voltage VO may be suppressed by the preset of the switching timings of the first signal S1, the second signal S2, the third signal S3, and the fourth signal S4 and the level of the error voltage VEAO.

After the second time interval TI2, in the first mode, the mode control circuit 150 may power on the power stage 112 by activating/increasing the second enable signal EN2 at/to the high level. For example, after the controller 113 presets the switching timings and the error voltage VEAO, the power stage 112 may be powered on to control the voltage converter 111.

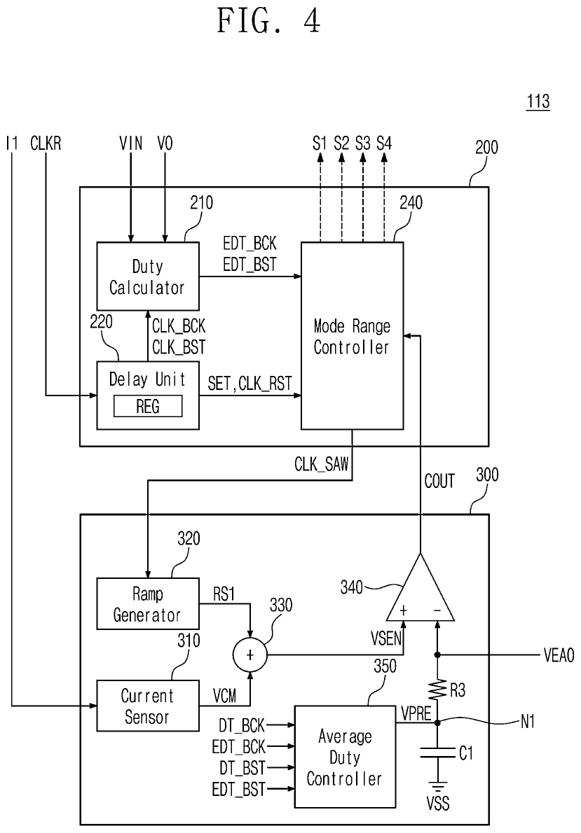

FIG. 4 illustrates the controller 113 according to an embodiment of the present disclosure. Referring to FIGS. 1 and 4, the controller 113 may include a control circuit 200 and a comparison circuit 300. The control circuit 200 may receive the input voltage VIN and the output voltage VO from the voltage converter 111. The control circuit 200 may receive the reference clock signal CLKR from the external device. The control circuit 200 may receive a comparison signal COUT from the comparison circuit 300. The control circuit 200 may control the first signal S1, the second signal S2, the third signal S3, and the fourth signal S4 based on the input voltage VIN, the output voltage VO, the reference clock signal CLKR, and the comparison signal COUT.

The control circuit 200 may include a duty calculator 210, a delay unit 220, and a mode range controller 240. The duty calculator 210 may receive the input voltage VIN and the output voltage VO. The duty calculator 210 may receive a buck clock signal CLK_BCK and a boost clock signal CLK_BST from the delay unit 220.

The duty calculator 210 may calculate a value corresponding to a ratio of the output voltage VO to the input voltage VIN based on the buck clock signal CLK_BCK. For example, the duty calculator 210 may output an emulated buck duty signal EDT_BCK with a duty corresponding to the ratio of the output voltage VO to the input voltage VIN. The emulated buck duty signal EDT_BCK may correspond to a target duty signal at the time of performing buck conversion based on the current level of the input voltage VIN and the current level of the output voltage VO.

The duty calculator 210 may calculate a value corresponding to a ratio of a difference between the output voltage VO and the input voltage VIN to the output voltage VO based on the boost clock signal CLK_BST. For example, the duty calculator 210 may output an emulated boost duty signal EDT_BST with a duty corresponding to the ratio of the difference between the output voltage VO and the input voltage VIN to the output voltage VO. The emulated boost duty signal EDT_BST may correspond to a target duty signal at the time of performing boost conversion based on the current level of the input voltage VIN and the current level of the output voltage VO.

For example, a first cycle may correspond to one period in which the first regulator 110 converts the input voltage VIN into the output voltage VO by charging and discharging internal elements (e.g., at least one inductor and at least one capacitor).

In the first cycle, a duty may correspond to a time interval in which the first regulator 110 charges the internal elements. For example, a buck duty may be determined by a buck duty signal DT_BCK and may correspond to a charging interval when the first regulator 110 performs buck conversion. A buck-boost duty may be determined by the buck duty signal DT_BCK and a boost duty signal DT_BST and may correspond to a charging interval when the first regulator 110 performs buck-boost conversion. A boost duty may be determined by the boost duty signal DT_BST and may correspond to a charging interval when the first regulator 110 performs boost conversion. The controller 113 may allow the first regulator 110 to repeatedly perform the first cycle such that the input voltage VIN is converted into the output voltage VO.

The delay unit 220 may receive the reference clock signal CLKR from the external device. The delay unit 220 may delay the reference clock signal CLKR based on information stored in a register REG included in the delay unit 220. The delay unit 220 may generate set signals SET and a reset clock signal CLK_RST by delaying the reference clock signal CLKR based on the information stored in the register REG. The set signals SET and the reset clock signal CLK_RST may be provided to the mode range controller 240.

The mode range controller 240 may receive the set signals SET and the reset clock signal CLK_RST from the delay unit 220. The mode range controller 240 may receive the emulated buck duty signal EDT_BCK and the emulated boost duty signal EDT_BST from the duty calculator 210. The mode range controller 240 may receive the comparison signal COUT from the comparison circuit 300. The mode range controller 240 may generate the first signal S1, the second signal S2, the third signal S3, the fourth signal S4, and a saw clock signal CLK_SAW based on the set signals SET, the reset clock signal CLK_RST, the emulated buck duty signal EDT_BCK, the emulated boost duty signal EDT_BST, and the comparison signal COUT.

For example, in the charging interval of the first cycle, the mode range controller 240 may control the first signal S1, the second signal S2, the third signal S3, and the fourth signal S4 such that a level of a charging voltage of at least one inductor or at least one capacitor therein increases.

When the comparison signal COUT transitions to the high level in the first cycle, the mode range controller 240 may start a discharging interval. In the discharging interval, the mode range controller 240 may control the first signal S1, the second signal S2, the third signal S3, and the fourth signal S4 such that a level of a charging voltage of at least one inductor or at least one capacitor therein decreases.

The comparison circuit 300 may include a current sensor 310, a ramp generator 320, an adder 330, a first comparator 340, an average duty controller 350, a first capacitor C1, and a third resistor R3. The current sensor 310 may receive the first current information I1 from the voltage converter 111. The current sensor 310 may output, as a current information voltage VCM, a voltage corresponding to a current amount which the first current information I1 indicates.

The ramp generator 320 may receive the saw clock signal CLK_SAW from the mode range controller 240 of the control circuit 200. The ramp generator 320 may output a first ramp signal RS1 which is reset in synchronization with the saw clock signal CLK_SAW. In an embodiment, a second cycle of the controller 113 may be determined based on the reset timing of the first ramp signal RS1. For example, a time interval from a point in time when the first ramp signal RS1 is reset to a point in time when the first ramp signal RS1 is again reset may be the second cycle. The first ramp signal RS1 may have a level which gradually increases from the level of the ground voltage VSS during the second cycle. The first ramp signal RS1 may be in the waveform of a sawtooth wave; in this case, in a plurality of second cycles, the first ramp signal RS1 may gradually increase and may then be reset.

The time length of the first cycle may be the same as the time length of the second cycle. The start timing of the first cycle and the start timing of the second cycle may be different from each other. Also, the end timing of the first cycle and the end timing of the second cycle may be different from each other.

The adder 330 may receive the current information voltage VCM from the current sensor 310 and may receive the first ramp signal RS1 from the ramp generator 320. The adder 330 may output a sensing voltage VSEN by adding the current information voltage VCM and the first ramp signal RS1. In an embodiment, the amplitude of the first ramp signal RS1 may be greater than the amplitude of the current information voltage VCM. Accordingly, the sensing voltage VSEN may have a trend line corresponding to the first ramp signal RS1, but the detailed level of the sensing voltage VSEN may be of a waveform which is adjusted by the current information voltage VCM.

The third resistor R3 and the first capacitor C1 may be connected in series between an output node of the error amplifier 140, from which the error voltage VEAO is output, and the ground node to which the ground voltage VSS is applied. In an embodiment, the error amplifier 140 may output a current, and the current output from the error amplifier 140 may be converted into the error voltage VEAO by the third resistor R3 and the first capacitor C1.

The comparator 340 may receive the sensing voltage VSEN and the error voltage VEAO. For example, the comparator 340 may receive the sensing voltage VSEN as a positive input and may receive the error voltage VEAO as a negative input. When the sensing voltage VSEN is lower than the error voltage VEAO, the first comparator 340 may output the comparison signal COUT at the low level. When the sensing voltage VSEN is higher than or equal to the error voltage VEAO, the first comparator 340 may output the comparison signal COUT at the high level.

The average duty controller 350 may receive the buck duty signal DT_BCK, the emulated buck duty signal EDT_BCK, the boost duty signal DT_BST, and the emulated boost duty signal EDT_BST. The average duty controller 350 may provide a preset voltage VPRE to a first node N1 between the third resistor R3 and the first capacitor C1, based on the buck duty signal DT_BCK, the emulated buck duty signal EDT_BCK, the boost duty signal DT_BST, and the emulated boost duty signal EDT_BST.

For example, as the average duty controller 350 provides the preset voltage VPRE to the first node N1, the switching timings and the error voltage VEAO may be preset during the second time interval TI2. The average duty controller 350 may control the duty of the buck duty signal DT_BCK and the duty of the boost duty signal DT_BST such that the duty of the buck duty signal DT_BCK comes close to the duty of the emulated buck duty signal EDT_BCK and such that the duty of the boost duty signal DT_BST comes close to the duty of the emulated boost duty signal EDT_BST.

In an embodiment, the buck duty signal DT_BCK may correspond to the first signal S1. The boost duty signal DT_BST may correspond to the third signal S3. The second signal S2 may be an inverted signal of the first signal S1. The fourth signal S4 may be an inverted signal of the third signal S3. The mode range controller 240 may control the first signal S1, the second signal S2, the third signal S3, and the fourth signal S4 based on the error voltage VEAO.

That is, the average duty controller 350 may form a negative feedback loop of again setting the error voltage VEAO based on the buck duty signal DT_BCK and the boost duty signal DT_BST whose duties are adjusted based on the error voltage VEAO. Based on the negative feedback loop, the duty of the buck duty signal DT_BCK may come close to the duty of the emulated buck duty signal EDT_BCK, and the duty of the boost duty signal DT_BST may come close to the duty of the emulated boost duty signal EDT_BST.

Accordingly, when the controller 113 enters the first mode from the second mode, based on the current level of the input voltage VIN, and the level of the output voltage VO, the switching timings of the first signal S1, the second signal S2, the third signal S3, and the fourth signal S4 may be optimal switching timings, and the level of the error voltage VEAO may be an optimal level. According to the above description, arbitrary switching timings and an arbitrary error voltage VEAO may be prevented/blocked from being applied to the first regulator 110 when the voltage conversion device 100 enters the first mode from the second mode, and the ripple of the output voltage VO may be suppressed.

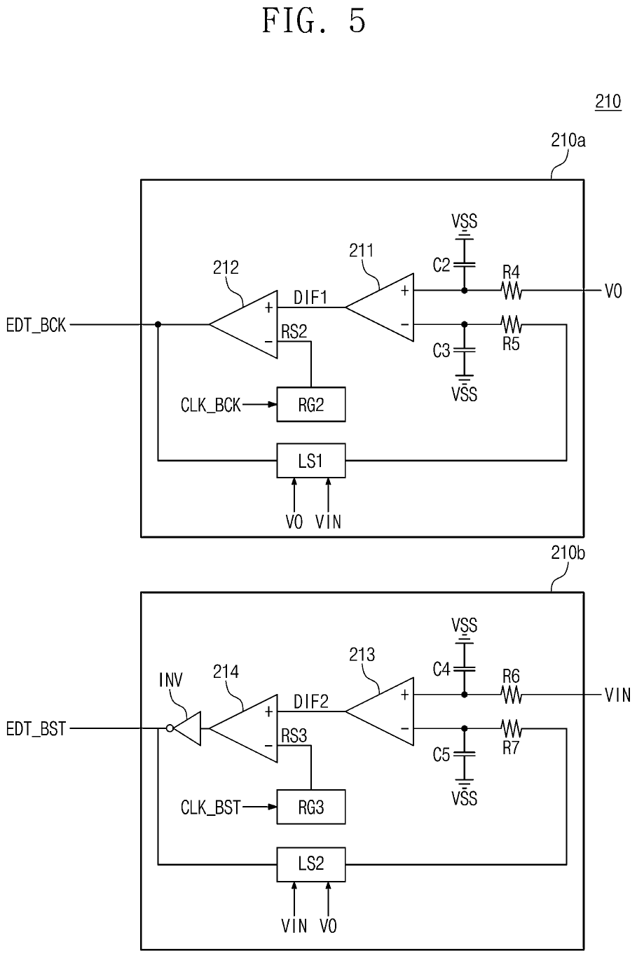

FIG. 5 illustrates the duty calculator 210 according to an embodiment of the present disclosure. Referring to FIG. 5, the duty calculator 210 may include a first duty calculator 210a and a second duty calculator 210b. The first duty calculator 210a may generate the emulated buck duty signal EDT_BCK. The second duty calculator 210b may generate the emulated boost duty signal EDT_BST.

The first duty calculator 210a may include a first amplifier 211, a second comparator 212, a second ramp generator RG2, a first level shifter LS1, a fourth resistor R4, a fifth resistor R5, a second capacitor C2, and a third capacitor C3.

A positive input of the first amplifier 211 may be connected to the second capacitor C2 and the fourth resistor R4. The second capacitor C2 may be connected between the positive input of the first amplifier 211 and the ground node to which the ground voltage VSS is applied. The fourth resistor R4 may transfer the output voltage VO to the positive input of the first amplifier 211.

A negative input of the first amplifier 211 may be connected to the fifth resistor R5 and the third capacitor C3. The third capacitor C3 may be connected between the negative input of the first amplifier 211 and the ground node to which the ground voltage VSS is applied. The fifth resistor R5 may transfer an output of the first level shifter LS1 to the negative input of the first amplifier 211.

The fourth resistor R4 and the second capacitor C2 may operate as a low pass filter. The fifth resistor R5 and the third capacitor C3 may operate as a low pass filter. The first amplifier 211 may output a first difference signal DIF1 based on 1) a signal obtained by filtering the output voltage VO through the low pass filter of the fourth resistor R4 and the second capacitor C2 and 2) a signal obtained by filtering the output of the first level shifter LS1 through the low pass filter of the fifth resistor R5 and the third capacitor C3. In an embodiment, the fourth resistor R4 and the second capacitor C2 may perform low pass filtering to convert an input signal with a duty into a DC level.

The second ramp generator RG2 may generate a second ramp signal RS2. In an embodiment, the second ramp generator RG2 may reset the second ramp signal RS2 in response to the buck clock signal CLK_BCK. That is, the cycle of the second ramp signal RS2 may be the same as the cycle of the buck clock signal CLK_BCK.

The second comparator 212 may receive the first difference signal DIF1 through a positive input and may receive the second ramp signal RS2 through a negative input. When the first difference signal DIF1 is smaller than the second ramp signal RS2, the output of the second comparator 212 may be set to the low level. When the first difference signal DIF1 is greater than or equal to the second ramp signal RS2, the output of the second comparator 212 may be set to the high level. The output of the second comparator 212 may be the emulated buck duty signal EDT_BCK.

The first amplifier 211 and the second comparator 212 may operate in a voltage domain of the output voltage VO. The low level of the second comparator 212 may correspond to the ground voltage VSS, and the high level of the second comparator 212 may correspond to the output voltage VO. The first level shifter LS1 may change the voltage domain of the output voltage VO to the voltage domain of the input voltage VIN. When the output of the second comparator 212 is at the low level of the ground voltage VSS, the output of the first level shifter LS1 may be at the low level of the ground voltage VSS. When the output of the second comparator 212 is at the high level of the output voltage VO, the output of the first level shifter LS1 may be at the high level of the input voltage VIN.

The low pass filter of the fifth resistor R5 and the third capacitor C3 may filter (e.g., integrate) the output of the first level shifter LS1. A filtering result of the low pass filter of the fifth resistor R5 and the third capacitor C3 may be transferred to the negative input of the first amplifier 211.

The second duty calculator 210b may include a second amplifier 213, a third comparator 214, a third ramp generator RG3, a second level shifter LS2, a sixth resistor R6, a seventh resistor R7, a fourth capacitor C4, a fifth capacitor C5, and an inverter INV.

A positive input of the second amplifier 213 may be connected to the sixth resistor R6 and the fourth capacitor C4. The fourth capacitor C4 may be connected between the positive input of the second amplifier 213 and the ground node to which the ground voltage VSS is applied. The sixth resistor R6 may transfer the input voltage VIN to the positive input of the second amplifier 213.

A negative input of the second amplifier 213 may be connected to the seventh resistor R7 and the fifth capacitor C5. The fifth capacitor C5 may be connected between the negative input of the second amplifier 213 and the ground node to which the ground voltage VSS is applied. The seventh resistor R7 may transfer an output of the second level shifter LS2 to the negative input of the second amplifier 213.

The sixth resistor R6 and the fourth capacitor C4 may operate as a low pass filter. The seventh resistor R7 and the fifth capacitor C5 may operate as a low pass filter. The second amplifier 213 may output a second difference signal DIF2 based on 1) a signal obtained by filtering the input voltage VIN through the low pass filter of the sixth resistor R6 and the fourth capacitor C4 and 2) a signal obtained by filtering the output of the second level shifter LS2 through the low pass filter of the seventh resistor R7 and the fifth capacitor C5.

The third ramp generator RG3 may generate a third ramp signal RS3. In an embodiment, the third ramp generator RG3 may reset the third ramp signal RS3 in response to the boost clock signal CLK_BST. That is, the cycle of the third ramp signal RS3 may be the same as the cycle of the boost clock signal CLK_BST.

The third comparator 214 may receive the second difference signal DIF2 through a positive input and may receive the third ramp signal RS3 through a negative input. When the second difference signal DIF2 is smaller than the third ramp signal RS3, the output of the third comparator 214 may be set to the low level. When the second difference signal DIF2 is greater than or equal to the third ramp signal RS3, the output of the third comparator 214 may be set to the high level. The output of the third comparator 214 may be transferred to the inverter INV. The output of the inverter INV may be the emulated boost duty signal EDT_BST.

The second amplifier 213, the third comparator 214, and the inverter INV may operate in a voltage domain of the input voltage VIN. The low level of the inverter INV may correspond to the ground voltage VSS, and the high level of the inverter INV may correspond to the input voltage VIN. The second level shifter LS2 may change the voltage domain of the input voltage VIN to the voltage domain of the output voltage VO. When the output of the inverter INV is at the low level of the ground voltage VSS, the output of the second level shifter LS2 may be at the low level of the ground voltage VSS. When the output of the inverter INV is at the high level of the input voltage VIN, the output of the second level shifter LS2 may be at the high level of the output voltage VO.

The low pass filter of the seventh resistor R7 and the fifth capacitor C5 may filter (e.g., integrate) the output of the second level shifter LS2. A filtering result of the low pass filter of the seventh resistor R7 and the fifth capacitor C5 may be transferred to the negative input of the second amplifier 213.

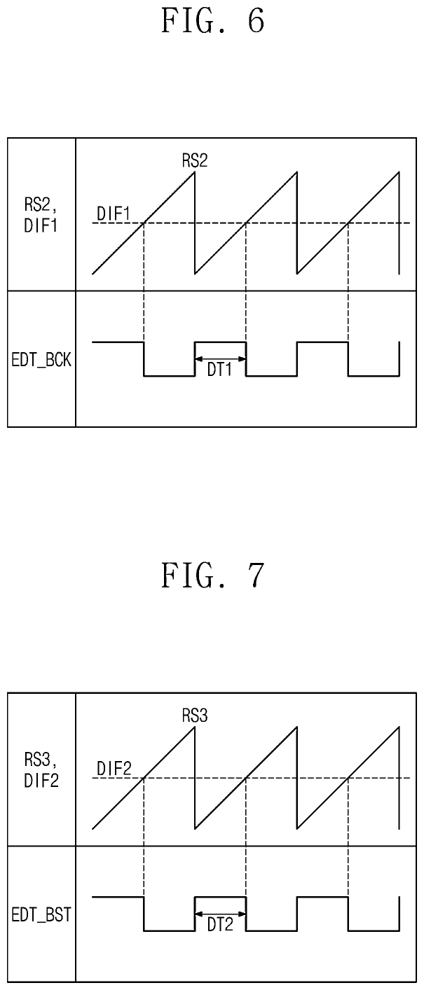

FIG. 6 illustrates an example of the second ramp signal RS2, the first difference signal DIF1, and the emulated buck duty signal EDT_BCK, according to an embodiment of the present disclosure. In an embodiment, how the second ramp signal RS2, the first difference signal DIF1, and the emulated buck duty signal EDT_BCK change over time is illustrated in FIG. 6.

In an embodiment, for brief description, an example in which the level of the first difference signal DIF1 is fixed is illustrated, but the level of the first difference signal DIF1 may change depending on the change in the level of the output voltage VO or the level of the input voltage VIN.

Referring to FIGS. 5 and 6, during a time interval where the first difference signal DIF1 is greater than or equal to the second ramp signal RS2, the emulated buck duty signal EDT_BCK may have the high level. During a time interval where the first difference signal DIF1 is smaller than the second ramp signal RS2, the emulated buck duty signal EDT_BCK may have the low level. The duty ratio of the emulated buck duty signal EDT_BCK may include information corresponding to the ratio of the level of the output voltage VO to the level of the input voltage VIN.

While the emulated buck duty signal EDT_BCK is at the high level, the output of the first level shifter LS1 may correspond to the input voltage VIN. The positive input of the second comparator 212 may correspond to an average level of the output voltage VO. The negative input of the second comparator 212 may correspond to an average level of the output of the first level shifter LS1. Accordingly, a first duty ratio DT1 of the emulated buck duty signal EDT_BCK may be determined by Equation 1 below.

$$DT 1 = \frac{VO}{VIN} \qquad [ Equation 1 ]$$

FIG. 7 illustrates an example of the third ramp signal RS3, the second difference signal DIF2, and the emulated boost duty signal EDT_BST, according to an embodiment of the present disclosure. In an embodiment, how the third ramp signal RS3, the second difference signal DIF2, and the emulated boost duty signal EDT_BST change over time is illustrated in FIG. 7.

In an embodiment, for brief description, an example in which the level of the second difference signal DIF2 is fixed is illustrated, but the level of the second difference signal DIF2 may change depending on the change in the level of the output voltage VO or the level of the input voltage VIN.

Referring to FIGS. 5 and 7, during a time interval where the second difference signal DIF2 is greater than or equal to the third ramp signal RS3, the emulated boost duty signal EDT_BST may have the high level. During a time interval where the second difference signal DIF2 is smaller than the third ramp signal RS3, the emulated boost duty signal EDT_BST may have the low level. The duty ratio of the emulated boost duty signal EDT_BST may include information about the level of the output voltage VO and the level of the input voltage VIN.

While the emulated boost duty signal EDT_BST is at the high level, the output of the second level shifter LS2 may correspond to the output voltage VO. The positive input of the third comparator 214 may correspond to an average level of the input voltage VIN. The negative input of the third comparator 214 may correspond to an average level of the output of the second level shifter LS2. Accordingly, a second duty ratio DT2 of the emulated boost duty signal EDT_BST may be determined by Equation 2 below.

$$DT 2 = \frac{VO - VIN}{VO} \qquad [ Equation 2 ]$$

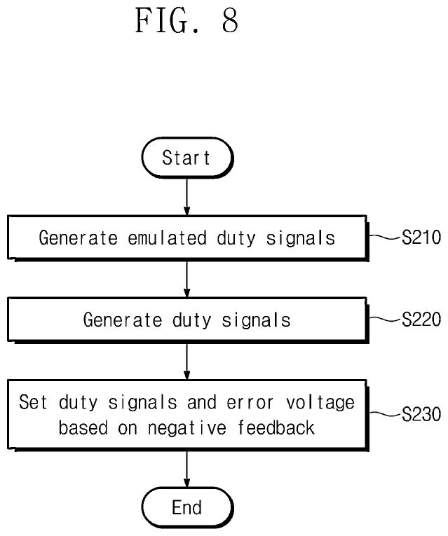

FIG. 8 illustrates an example of a method in which the first regulator 110 of the voltage conversion device 100 presets switching timings and an error voltage. Referring to FIGS. 1, 4, and 8, in operation S210, the first regulator 110 may generate emulated duty signals. For example, the duty calculator 210 of the control circuit 200 may generate the emulated buck duty signal EDT_BCK and the emulated boost duty signal EDT_BST based on the input voltage VIN and the output voltage VO.

In operation S220, the first regulator 110 may generate duty signals. For example, the mode range controller 240 of the control circuit 200 may generate the first signal S1, the second signal S2, the third signal S3, and the fourth signal S4 based on the emulated buck duty signal EDT_BCK, the emulated boost duty signal EDT_BST, the set signals SET, the reset clock signal CLK_RST, and the comparison signal COUT. The first signal S1 may correspond to the buck duty signal DT_BCK, and the third signal S3 may correspond to the boost duty signal DT_BST.

In operation S230, the first regulator 110 may set the duty signals and the error voltage VEAO based on the negative feedback. For example, the average duty controller 350 of the comparison circuit 300 may apply a difference between the duty of the buck duty signal DT_BCK and the duty of the emulated buck duty signal EDT_BCK and a difference between the duty of the boost duty signal DT_BST and the duty of the emulated boost duty signal EDT_BST to the level of the preset voltage VPRE.

The level of the preset voltage VPRE may be applied to the level of the error voltage VEAO. The level of the error voltage VEAO may be applied to the timing at which the comparison signal COUT transitions to the high level. The timing at which the comparison signal COUT transitions to the high level may be applied to the switching timings of the first signal S1, the second signal S2, the third signal S3, and the fourth signal S4. The switching timings of the first signal S1 and the third signal S3, that is, the buck duty signal DT_BCK and the boost duty signal DT_BST may be again applied to the preset voltage VPRE by the average duty controller 350. The control circuit 200 and the comparison circuit 300 may perform the preset operation of reducing the difference between the duty of the buck duty signal DT_BCK and the duty of the emulated buck duty signal EDT_BCK and reducing the difference between the duty of the boost duty signal DT_BST and the duty of the emulated boost duty signal EDT_BST.

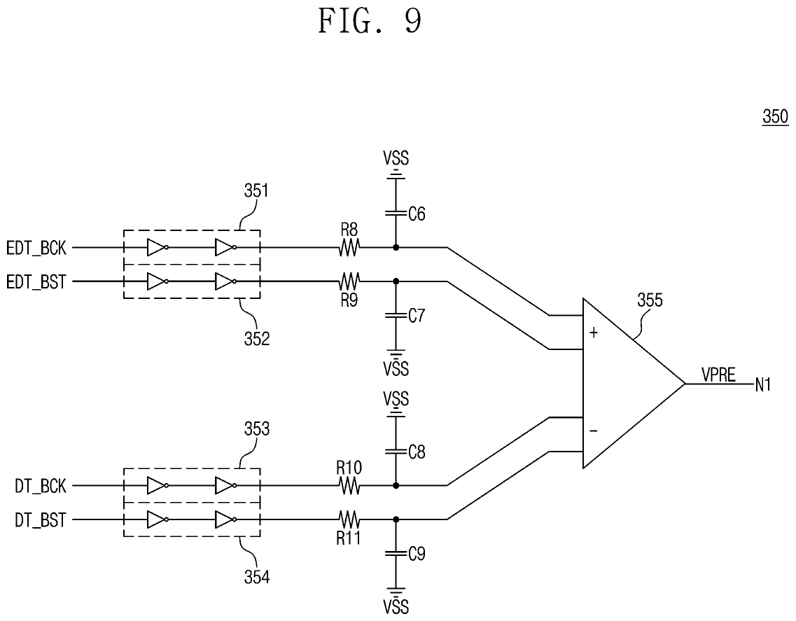

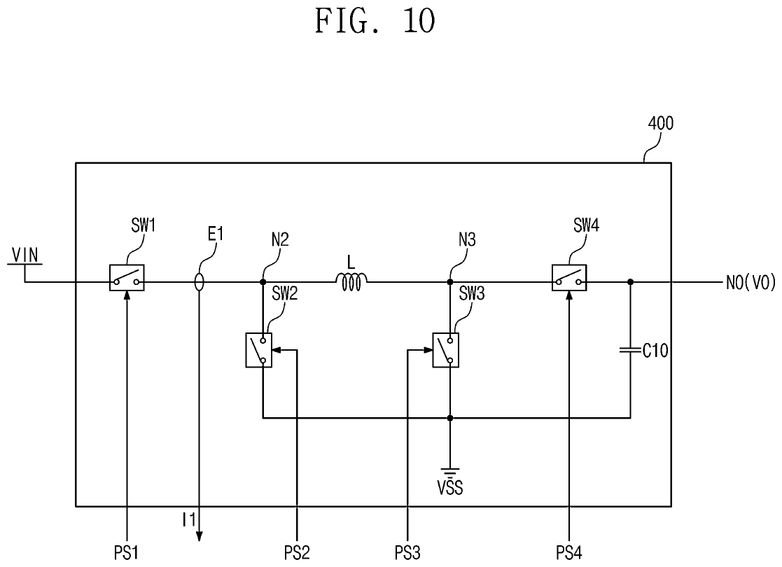

FIG. 9 illustrates the average duty controller 350 according to an embodiment of the present disclosure. Referring to FIGS. 4 and 9, the average duty controller 350 may include a first buffer block 351, a second buffer block 352, a third buffer block 353, a fourth buffer block 354, a third amplifier 355, a sixth capacitor C6, a seventh capacitor C7, an eighth capacitor C8, a ninth capacitor C9, an eighth resistor R8, a ninth resistor R9, a tenth resistor R10, and an eleventh resistor R11.

The first buffer block 351 may buffer and output the emulated buck duty signal EDT_BCK. The first buffer block 351 may include an even number of inverters. The second buffer block 352 may buffer and output the emulated boost duty signal EDT_BST. The second buffer block 352 may include an even number of inverters.

The third buffer block 353 may buffer and output the buck duty signal DT_BCK. The third buffer block 353 may include an even number of inverters. The fourth buffer block 354 may buffer and output the boost duty signal DT_BST. The fourth buffer block 354 may include an even number of inverters.

The output of the first buffer block 351 may be transferred to a first positive input of the third amplifier 355 through the eighth resistor R8. The sixth capacitor C6 may be connected between the first positive input of the third amplifier 355 and the ground node to which the ground voltage VSS is applied. The eighth resistor R8 and the sixth capacitor C6 may operate as an integrator. The eighth resistor R8 and the sixth capacitor C6 may integrate the emulated buck duty signal EDT_BCK transferred through the first buffer block 351. That is, the eighth resistor R8 and the sixth capacitor C6 may transfer a voltage having a level corresponding to the duty ratio of the emulated buck duty signal EDT_BCK to the first positive input of the third amplifier 355.

The output of the second buffer block 352 may be transferred to a second positive input of the third amplifier 355 through the ninth resistor R9. The seventh capacitor C7 may be connected between the second positive input of the third amplifier 355 and the ground node to which the ground voltage VSS is applied. The ninth resistor R9 and the seventh capacitor C7 may operate as an integrator. The ninth resistor R9 and the seventh capacitor C7 may integrate the emulated boost duty signal EDT_BST transferred through the second buffer block 352. That is, the ninth resistor R9 and the seventh capacitor C7 may transfer a voltage having a level corresponding to the duty ratio of the emulated boost duty signal EDT_BST to the second positive input of the third amplifier 355.

The output of the third buffer block 353 may be transferred to a first negative input of the third amplifier 355 through the tenth resistor R10. The eighth capacitor C8 may be connected between the first negative input of the third amplifier 355 and the ground node to which the ground voltage VSS is applied. The tenth resistor R10 and the eighth capacitor C8 may operate as an integrator. The tenth resistor R10 and the eighth capacitor C8 may integrate the buck duty signal DT_BCK transferred through the third buffer block 353. That is, the tenth resistor R10 and the eighth capacitor C8 may transfer a voltage having a level corresponding to the duty ratio of the buck duty signal DT_BCK to the first negative input of the third amplifier 355.

The output of the fourth buffer block 354 may be transferred to a second negative input of the third amplifier 355 through the eleventh resistor R11. The ninth capacitor C9 may be connected between the second negative input of the third amplifier 355 and the ground node to which the ground voltage VSS is applied. The eleventh resistor R11 and the ninth capacitor C9 may operate as an integrator. The eleventh resistor R11 and the ninth capacitor C9 may integrate the boost duty signal DT_BST transferred through the fourth buffer block 354. That is, the eleventh resistor R11 and the ninth capacitor C9 may transfer a voltage having a level corresponding to the duty ratio of the boost duty signal DT_BST to the second negative input of the third amplifier 355.

The third amplifier 355 may amplify a difference between the voltage level corresponding to the duty ratio of the emulated buck duty signal EDT_BCK of the first positive input and the voltage level corresponding to the duty ratio of the buck duty signal DT_BCK of the first negative input so as to be applied to the preset voltage VPRE. The third amplifier 355 may amplify a difference between the voltage level corresponding to the duty ratio of the emulated boost duty signal EDT_BST of the second positive input and the voltage level corresponding to the duty ratio of the boost duty signal DT_BST of the second negative input so as to be applied to the preset voltage VPRE.

For example, the third amplifier 355 may amplify a sum of the difference between the voltage level of the first positive input and the voltage level of the first negative input and the difference between the voltage level of the second positive input and the voltage level of the second negative input so as to be output as the preset voltage VPRE. The preset voltage VPRE may be transferred to the first node N1.

FIG. 10 illustrates a voltage converter 400 according to an embodiment of the present disclosure. In an embodiment, the voltage converter 400 may correspond to the voltage converter 111 of FIG. 1. Referring to FIGS. 1 and 10, the voltage converter 400 may include a first switch SW1, a second switch SW2, a third switch SW3, a fourth switch SW4, at least one inductor L, and at least one capacitor (e.g., a tenth capacitor C10).

The first switch SW1 may be connected between an input node to which the input voltage VIN is transferred and a second node N2. The first switch SW1 may be controlled by the first power signal PS1 transferred from the power stage 112. The second switch SW2 may be connected between the second node N2 and the ground node to which the ground voltage VSS is input. The second switch SW2 may be controlled by the second power signal PS2 transferred from the power stage 112.

The third switch SW3 may be connected between a third node N3 and the ground node to which the ground voltage VSS is input. The third switch SW3 may be controlled by the third power signal PS3 transferred from the power stage 112. The fourth switch SW4 may be connected between the third node N3 and the output node NO from which the output voltage VO is output. The fourth switch SW4 may be controlled by the fourth power signal PS4 transferred from the power stage 112.

The tenth capacitor C10 may be connected between the output node NO and the ground node.

The voltage converter 400 may further include a first current extractor E1. The first current extractor E1 may extract a current flowing to the second node N2 through the first switch SW1, for example, the first current information I1. The first current information I1 may be transferred to the controller 113. The first current information I1 may correspond to a voltage having a level indicating a current or a current amount/magnitude.

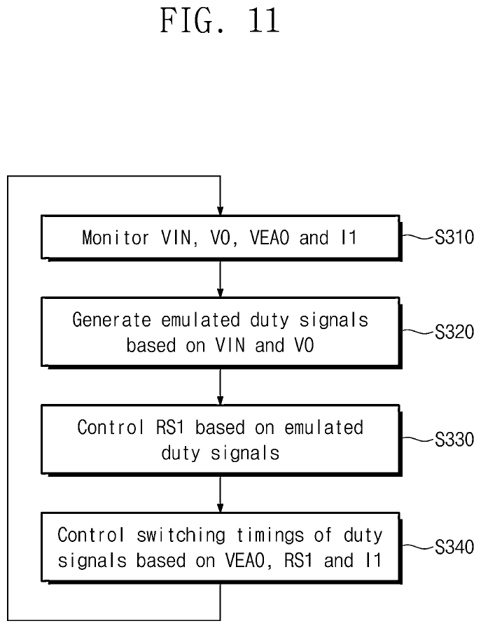

FIG. 11 illustrates an example of a method in which the first regulator 110 converts the input voltage VIN into the output voltage VO in the first mode. Referring to FIGS. 1, 4, and 11, in operation S310, the first regulator 110 may monitor/receive the input voltage VIN, the output voltage VO, the error voltage VEAO, and the first current information I1. For example, the controller 113 of the first regulator 110 may monitor/receive the input voltage VIN, the output voltage VO, the error voltage VEAO, and the first current information I1.

In operation S320, the first regulator 110 may generate emulated duty signals based on the input voltage VIN and the output voltage VO. For example, the duty calculator 210 of the control circuit 200 may generate the emulated buck duty signal EDT_BCK and the emulated boost duty signal EDT_BST based on the input voltage VIN and the output voltage VO.

In operation S330, the first regulator 110 may control the first ramp signal RS1 based on the emulated duty signals. For example, the mode range controller 240 of the control circuit 200 may adjust the reset timing of the first ramp signal RS1 by adjusting the toggling timing of the saw clock signal CLK_SAW based on the emulated buck duty signal EDT_BCK and the emulated boost duty signal EDT_BST. That is, the mode range controller 240 may convert the input voltage VIN into the output voltage VO by adjusting a difference between the first cycle determined by the charging interval and the discharging interval and the second cycle determined by the saw clock signal CLK_SAW. In some embodiments, in the first mode, the controller 113 may perform buck conversion by adjusting a reset timing of the first ramp signal RS1 based on the emulated buck duty signal EDT_BCK. Moreover, in the first mode, the controller 113 may perform boost conversion and/or buck-boost conversion by adjusting a reset timing of the first ramp signal RS1 based on the emulated boost duty signal EDT_BST.

In operation S340, the first regulator 110 may control switching timings of duty signals based on the error voltage VEAO, the first ramp signal RS1, and the first current information I1. Because the mode range controller 240 controls the reset timing of the first ramp signal RS1, the timing at which the first ramp signal RS1 is greater than a sum of the error voltage VEAO and the current information voltage VCM may change. That is, the timing at which the comparison signal COUT of the first comparator 340 included in the comparison circuit 300 transitions to the high level may change. As the timing at which the comparison signal COUT transitions to the high level changes, the switching timings of the first signal S1, the second signal S2, the third signal S3, and the fourth signal S4 may change.

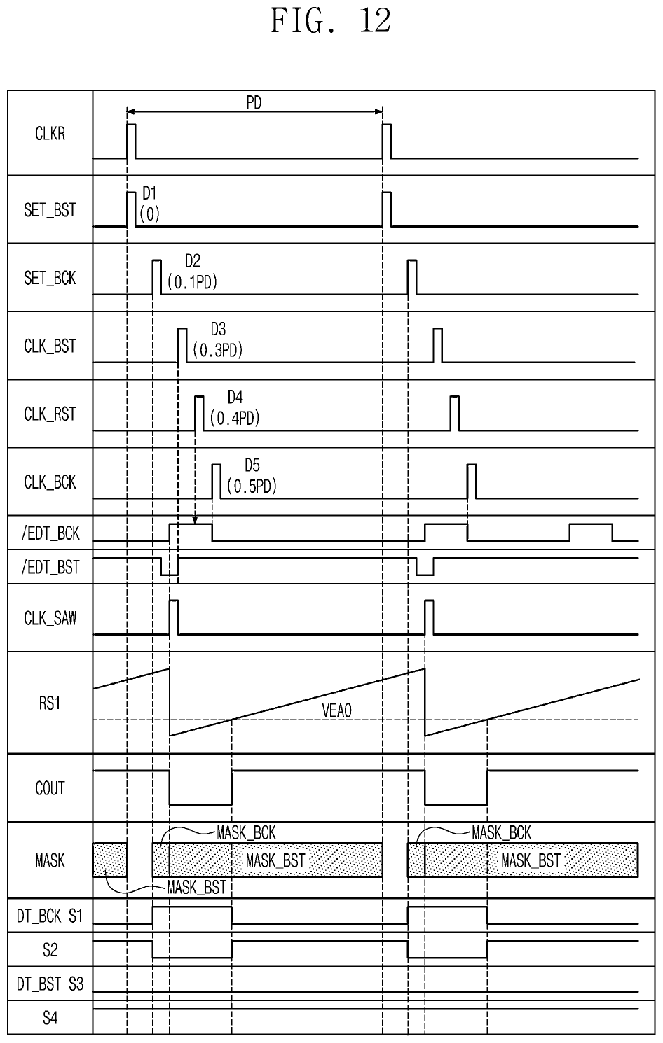

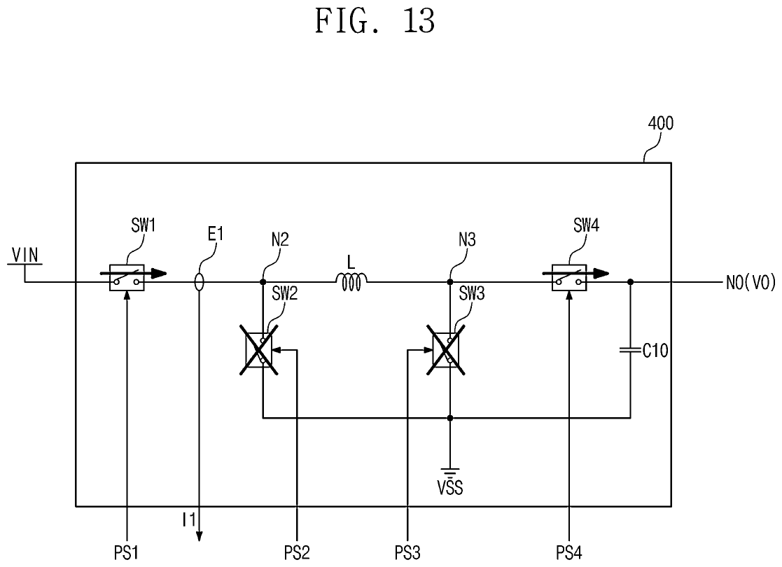

FIG. 12 illustrates a first example of signals of the first regulator 110 according to an embodiment of the present disclosure. In an embodiment, an example in which when the first regulator 110 performs buck conversion, signals of the first regulator 110 change over time is illustrated in FIG. 12.

Referring to FIG. 12, the delay unit 220 may receive the reference clock signal CLKR. The reference clock signal CLKR may be a signal which toggles based on a period PD.

The delay unit 220 may delay the reference clock signal CLKR as much as a first delay value D1 stored in the register REG and may generate a set boost signal SET_BST. The first delay value D1 may be “0”. The set boost signal SET_BST may be included in the set signals SET which are provided to the mode range controller 240. The set boost signal SET_BST may be used to control the third signal S3 (or the boost duty signal DT_BST) and the fourth signal S4 associated with boost conversion. The mode range controller 240 may allow the fourth signal S4 to transition to the high level (e.g., maintain the fourth signal S4 at high level) in synchronization with the set boost signal SET_BST. The mode range controller 240 may invert the fourth signal S4 to generate the third signal S3.

The delay unit 220 may delay the reference clock signal CLKR as much as a second delay value D2 stored in the register REG and may generate a set buck signal SET_BCK. The second delay value D2 may be “0.1PD”. The set buck signal SET_BCK may be included in the set signals SET which are provided to the mode range controller 240. The set buck signal SET_BCK may be used to control the first signal S1 (or the buck duty signal DT_BCK) and the second signal S2 associated with buck conversion. The mode range controller 240 may allow the first signal S1 to transition to the high level in synchronization with the set buck signal SET_BCK. The mode range controller 240 may invert the first signal S1 to generate the second signal S2.

The delay unit 220 may delay the reference clock signal CLKR as much as a third delay value D3 stored in the register REG and may generate the boost clock signal CLK_BST. The third delay value D3 may be “0.3PD”. The boost clock signal CLK_BST may be provided to the duty calculator 210. The boost clock signal CLK_BST may be used to generate the emulated boost duty signal EDT_BST. For example, the duty calculator 210 may generate the emulated boost duty signal EDT_BST in synchronization with the boost clock signal CLK_BST.

The delay unit 220 may delay the reference clock signal CLKR as much as a fourth delay value D4 stored in the register REG and may generate the reset clock signal CLK_RST. The fourth delay value D4 may be “0.4PD”. The reset clock signal CLK_RST may be provided to the mode range controller 240. The reset clock signal CLK_RST may be used to determine whether the mode range controller 240 performs buck conversion or performs one of buck-boost conversion and boost conversion.

The delay unit 220 may delay the reference clock signal CLKR as much as a fifth delay value D5 stored in the register REG and may generate the buck clock signal CLK_BCK. The fifth delay value D5 may be “0.5PD”. The buck clock signal CLK_BCK may be provided to the duty calculator 210. The buck clock signal CLK_BCK may be used to generate the emulated buck duty signal EDT_BCK. For example, the duty calculator 210 may generate the emulated buck duty signal EDT_BCK in synchronization with the buck clock signal CLK_BCK.

The mode range controller 240 may receive the emulated buck duty signal EDT_BCK and the emulated boost duty signal EDT_BST from the duty calculator 210. The mode range controller 240 may invert the emulated buck duty signal EDT_BCK to generate an inverted emulated buck duty signal/EDT_BCK. The mode range controller 240 may invert the emulated boost duty signal EDT_BST to generate an inverted emulated boost duty signal/EDT_BST.

The inverted emulated buck duty signal/EDT_BCK may be used to determine whether the mode range controller 240 performs buck conversion or performs one of buck-boost conversion and boost conversion. For example, the mode range controller 240 may monitor the inverted emulated buck duty signal/EDT_BCK in synchronization with the reset clock signal CLK_RST.

When the inverted emulated buck duty signal/EDT_BCK is at the high level at a point in time when the reset clock signal CLK_RST transitions from the low level to the high level, the mode range controller 240 may perform buck conversion. When the inverted emulated buck duty signal/EDT_BCK is at the low level at a point in time when the reset clock signal CLK_RST transitions from the low level to the high level, the mode range controller 240 may perform buck-boost conversion or boost conversion.

That is, the reset clock signal CLK_RST may act as a threshold value for the inverted emulated buck duty signal/EDT_BCK. When the inverted emulated buck duty signal/EDT_BCK is at the high level at the rising edge of the reset clock signal CLK_RST, the duty of the inverted emulated buck duty signal/EDT_BCK may be regarded as being longer than the threshold value. When the inverted emulated buck duty signal/EDT_BCK is at the low level at the rising edge of the reset clock signal CLK_RST, the duty of the inverted emulated buck duty signal/EDT_BCK may be regarded as being shorter than or equal to the threshold value.

An example in which the inverted emulated buck duty signal/EDT_BCK is at the high level at the rising edge of the reset clock signal CLK_RST is illustrated in FIG. 12. That is, the mode range controller 240 may perform buck conversion.

The inverted emulated buck duty signal/EDT_BCK and the inverted emulated boost duty signal/EDT_BST may be used to generate the saw clock signal CLK_SAW. For example, when the mode range controller 240 performs buck conversion, the saw clock signal CLK_SAW may toggle in synchronization with the rising edge of the inverted emulated buck duty signal/EDT_BCK under control of the mode range controller 240. When the mode range controller 240 performs buck-boost conversion or boost conversion, the saw clock signal CLK_SAW may toggle in synchronization with the rising edge of the inverted emulated boost duty signal/EDT_BST under control of the mode range controller 240.

In FIG. 12, because the mode range controller 240 performs buck conversion, the saw clock signal CLK_SAW may toggle in synchronization with the rising edge of the inverted emulated buck duty signal/EDT_BCK under control of the mode range controller 240. In an embodiment, the mode range controller 240 may generate the saw clock signal CLK_SAW by using one of the reference clock signal CLKR, the set boost signal SET_BST, the set buck signal SET_BCK, the boost clock signal CLK_BST, the reset clock signal CLK_RST, and the buck clock signal CLK_BCK.

The first ramp signal RS1 may be reset in synchronization with the saw clock signal CLK_SAW. The first ramp signal RS1 is illustrated as overlapping the error voltage VEAO to make the comparison of the first ramp signal RS1 and the error voltage VEAO easy.

The comparison signal COUT may be at the low level when the first ramp signal RS1 is lower than (or lower than or equal to) the error voltage VEAO. The comparison signal COUT may be at the high level when the first ramp signal RS1 is higher than (or higher than or equal to) the error voltage VEAO.

The cycle of the comparison signal COUT may be synchronized with the second cycle of the first ramp signal RS1. The comparison signal COUT may be used to determine the timing to start discharging in the second cycle determined by the charging interval and the discharging interval. For example, when the comparison signal COUT transitions from the low level to the high level, the mode range controller 240 may control the first signal S1, the second signal S2, the third signal S3, and the fourth signal S4 such that discharging is initiated.

For example, when the comparison signal COUT transitions from the low level to the high level at a point in time when the first signal S1 (or the buck duty signal DT_BCK) is at the high level, the first signal S1 may transition from the high level to the low level under control of the mode range controller 240. Accordingly, the second signal S2 may transition from the low level to the high level.

When the comparison signal COUT transitions from the low level to the high level at a point in time when the fourth signal S4 is at the high level, the fourth signal S4 may transition from the high level to the low level under control of the mode range controller 240. Accordingly, the third signal S3 (or the boost duty signal DT_BST) may transition from the low level to the high level.

A mask signal MASK may include a buck mask signal MASK_BCK and a boost mask signal MASK_BST. The mask signal MASK may prevent/block the mode range controller 240 from performing discharging.

For example, when the buck mask signal MASK_BCK is activated, the mode range controller 240 may prevent/block the first signal S1 (or the buck duty signal DT_BCK) from transitioning from the low level to the high level even though the comparison signal COUT transitions from the low level to the high level. Accordingly, the second signal S2 may also be prevented/blocked from transitioning from the low level to the high level.

When the boost mask signal MASK_BST is activated, the mode range controller 240 may prevent/block the fourth signal S4 from transitioning from the high level to the low level even though the comparison signal COUT transitions from the low level to the high level. Accordingly, the third signal S3 (or the boost duty signal DT_BST) may also be prevented/blocked from transitioning from the low level to the high level.

In an embodiment, the buck mask signal MASK_BCK may be activated in synchronization with the set buck signal SET_BCK and may be deactivated in synchronization with the saw clock signal CLK_SAW. The boost mask signal MASK_BST may be activated in synchronization with the saw clock signal CLK_SAW and may be deactivated in synchronization with the reference clock signal CLKR.

In the buck conversion of the first mode, the first signal S1 (or the buck duty signal DT_BCK) may transition to the high level in synchronization with the set buck signal SET_BCK. When the comparison signal COUT transitions from the low level to the high level, the buck mask signal MASK_BCK may be in an inactive state. Accordingly, the first signal S1 (or the buck duty signal DT_BCK) may transition from the high level to the low level when the comparison signal COUT transitions from the low level to the high level. The second signal S2 may be an inverted signal of the first signal S1 (or the buck duty signal DT_BCK).

The fourth signal S4 may transition to the high level in synchronization with the set boost signal SET_BST. When the comparison signal COUT transitions from the low level to the high level, the boost mask signal MASK_BST may be in an active state. Accordingly, when the comparison signal COUT transitions from the low level to the high level, the fourth signal S4 may maintain the high level.

In the buck conversion of the first mode, the fourth signal S4 may maintain the high level. The third signal S3 (or the boost duty signal DT_BST) may be an inverted signal of the fourth signal S4. In the buck conversion of the first mode, the third signal S3 (or the boost duty signal DT_BST) may maintain the low level.

In the buck conversion of the first mode, the start timing of the charging interval of the first cycle determined by the charging interval and the discharging interval may correspond to the rising edge of the set buck signal SET_BCK, at which the first signal S1 (or the buck duty signal DT_BCK) transitions from the low level to the high level. In the buck conversion of the first mode, the end timing of the charging interval of the first cycle or the start timing of the discharging interval of the first cycle may correspond to the rising edge of the comparison signal COUT. In the buck conversion of the first mode, the end timing of the discharging interval of the first cycle may correspond to the rising edge of the set buck signal SET_BCK. In the buck conversion of the first mode, the second cycle of the first ramp signal RS1 may be synchronized with the saw clock signal CLK_SAW.

FIG. 13 illustrates an example in which the voltage converter 400 controls the first switch SW1, the second switch SW2, the third switch SW3, and the fourth switch SW4 in the charging interval of the buck conversion manner of the first mode.

Referring to FIGS. 12 and 13, in the charging interval of the buck conversion manner, the power stage 112 may turn on the first switch SW1, may turn off the second switch SW2, may turn off the third switch SW3, and may turn on the fourth switch SW4.

The input voltage VIN may be connected to an electrical path including the first switch SW1, the inductor L, the tenth capacitor C10, and the ground node to which the ground voltage VSS is applied and may charge the inductor L and the tenth capacitor C10. A voltage which is obtained by dividing the input voltage VIN through the inductor L and the tenth capacitor C10 may be output as the output voltage VO.

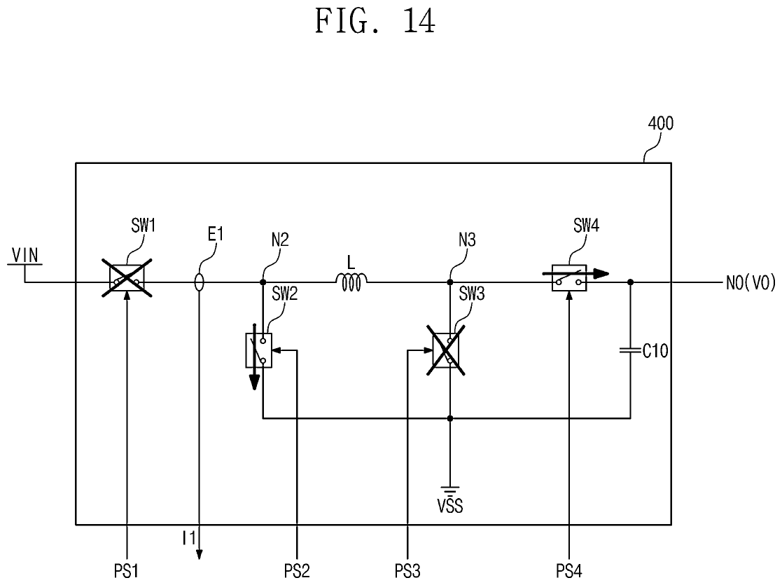

FIG. 14 illustrates an example in which the voltage converter 400 controls the first switch SW1, the second switch SW2, the third switch SW3, and the fourth switch SW4 in the discharging interval of the buck conversion manner of the first mode.

Referring to FIGS. 12 and 14, in the discharging interval of the buck conversion manner, the controller 113 may turn off the first switch SW1, may turn on the second switch SW2, may turn off the third switch SW3, and may turn on the fourth switch SW4.

The inductor L and the tenth capacitor C10 may be connected in parallel between the output node NO and the ground node. The charges which are stored in the inductor L and the tenth capacitor C10 may be output as the output voltage VO.

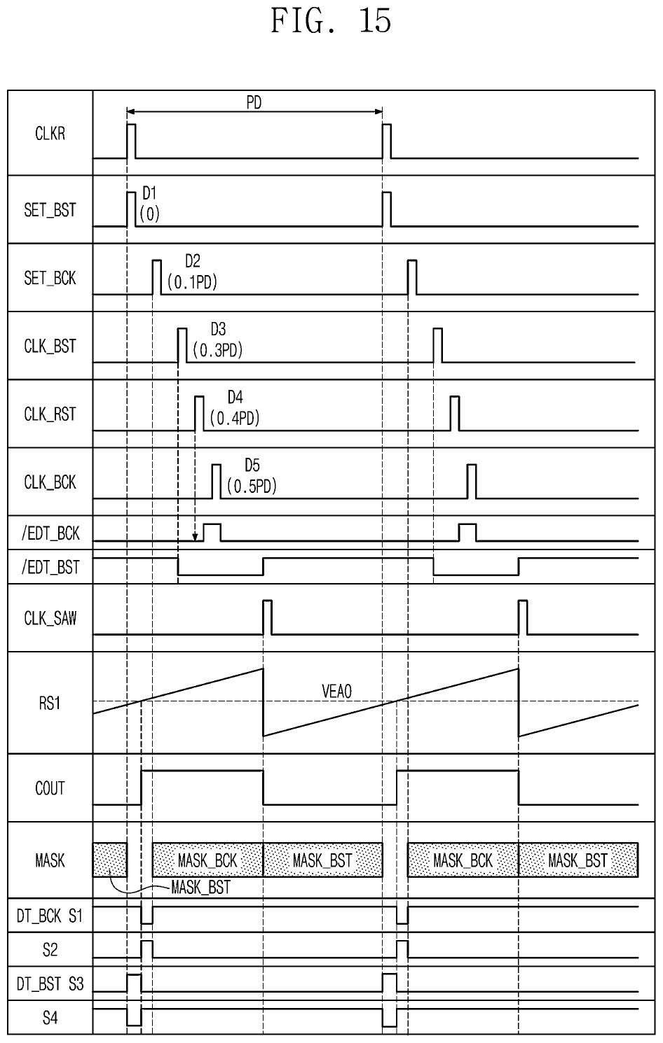

FIG. 15 illustrates a second example of signals of the first regulator 110 according to an embodiment of the present disclosure. In an embodiment, an example in which when the first regulator 110 performs buck-boost conversion, signals of the first regulator 110 change over time is illustrated in FIG. 15.

The reference clock signal CLKR, the set boost signal SET_BST, the set buck signal SET_BCK, the boost clock signal CLK_BST, the reset clock signal CLK_RST, and the buck clock signal CLK_BCK may toggle at timings the same as the timings of FIG. 12 and may maintain cycles the same as the cycles of FIG. 12.

Because the inverted emulated buck duty signal/EDT_BCK is at the low level at the rising edge of the reset clock signal CLK_RST, the saw clock signal CLK_SAW may toggle in synchronization with the rising edge of the inverted emulated buck duty signal/EDT_BCK under control of the mode range controller 240. That is, the first ramp signal RS1 may be reset in synchronization with the rising edge of the inverted emulated boost duty signal/EDT_BST.

In the buck-boost conversion of the first mode, the first signal S1 (or the buck duty signal DT_BCK) may transition from the low level to the high level in synchronization with the rising edge of the set buck signal SET_BCK. When the comparison signal COUT transitions from the low level to the high level, the buck mask signal MASK_BCK may be in an inactive state. Accordingly, the first signal S1 (or the buck duty signal DT_BCK) may transition to the high level when the comparison signal COUT transitions from the low level to the high level. The second signal S2 may be an inverted signal of the first signal S1 (or the buck duty signal DT_BCK).

In the buck-boost conversion of the first mode, the fourth signal S4 may transition from the low level to the high level in synchronization with the rising edge of the set boost signal SET_BST. When the comparison signal COUT transitions from the low level to the high level, the boost mask signal MASK_BST may be in an inactive state. Accordingly, when the comparison signal COUT transitions from the low level to the high level, the fourth signal S4 may transition from the low level to the high level.

In the buck-boost conversion of the first mode, the start timing of the charging interval of the first cycle determined by the charging interval may correspond to the rising edge of the set buck signal SET_BCK, at which the first signal S1 (or the buck duty signal DT_BCK) transitions from the low level to the high level. In the buck-boost conversion of the first mode, the end timing of the charging interval of the first cycle or the start timing of the discharging interval of the first cycle may correspond to the rising edge of the comparison signal COUT. In the buck-boost conversion of the first mode, the end timing of the discharging interval of the first cycle may correspond to the rising edge of the set buck signal SET_BCK. In the buck-boost conversion of the first mode, the second cycle of the first ramp signal RS1 may be synchronized with the saw clock signal CLK_SAW.

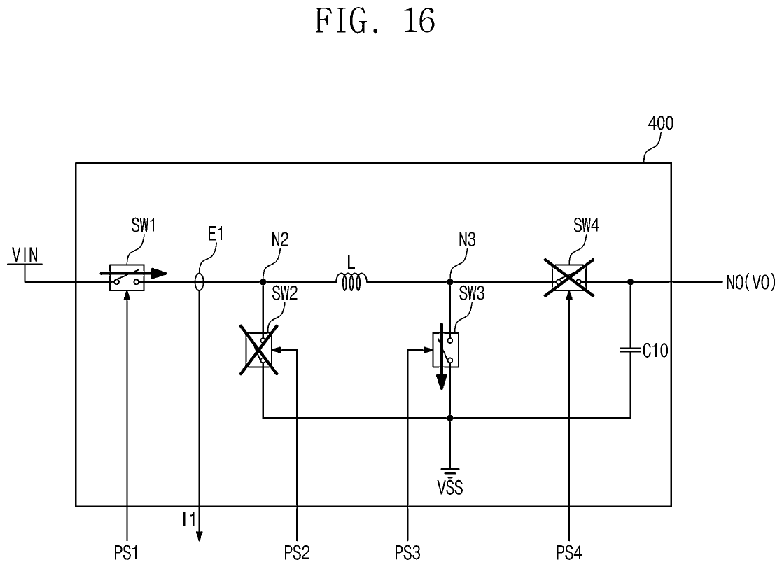

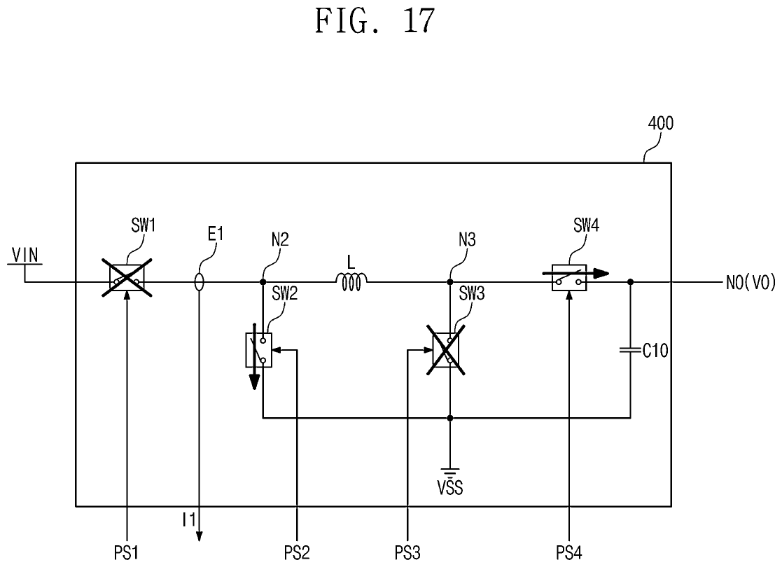

FIG. 16 illustrates an example in which the voltage converter 111 controls the first switch SW1, the second switch SW2, the third switch SW3, and the fourth switch SW4 in the charging interval of the buck-boost conversion manner of the first mode.

Referring to FIGS. 15 and 16, in an embodiment, in the charging interval of the buck-boost conversion manner of the first mode, from the rising edge of the set buck signal SET_BCK to the rising edge of the set boost signal SET_BST, the power stage 112 may control the first switch SW1, the second switch SW2, the third switch SW3, and the fourth switch SW4 to be identical to the charging interval of the buck conversion manner described with reference to FIGS. 12 and 13.

At the rising edge of the set boost signal SET_BST, the power stage 112 may turn on the first switch SW1, may turn off the second switch SW2, may turn on the third switch SW3, and may turn off the fourth switch SW4. That is, at the rising edge of the set boost signal SET_BST, the power stage 112 may operate in the charging interval of the buck-boost conversion manner of the first mode.

In the charging interval of the buck-boost conversion manner of the first mode, the input voltage VIN may be connected to an electrical path including the first switch SW1, the inductor L, and the ground node to which the ground voltage VSS is applied and may charge the inductor L.

FIG. 17 illustrates an example in which the voltage conversion device 100 (e.g., the voltage converter 400 therein) controls the first switch SW1, the second switch SW2, the third switch SW3, and the fourth switch SW4 in the discharging interval of the buck-boost conversion manner of the first mode.

Referring to FIGS. 15 and 17, in the discharging interval of the first mode buck-boost conversion manner, the power stage 112 may turn off the first switch SW1, may turn on the second switch SW2, may turn off the third switch SW3, and may turn on the fourth switch SW4.

The inductor L and the tenth capacitor C10 may be connected in parallel between the output node NO and the ground node. The charges which are stored in the inductor L may charge the tenth capacitor C10 and may be output as the output voltage VO.

As described with reference to FIGS. 12, 13, and 14, when the charging interval of the voltage converter 111 ends in the buck conversion manner of the first mode, the voltage converter 111 may perform discharging of the buck conversion manner of the first mode in the discharging interval. As described with reference to FIGS. 15, 16, and 17, when the charging interval of the voltage converter 111 passes through the buck conversion manner of the first mode and ends in the buck-boost conversion manner of the first mode, the voltage converter 111 may perform discharging of the buck-boost conversion manner of the first mode in the discharging interval.

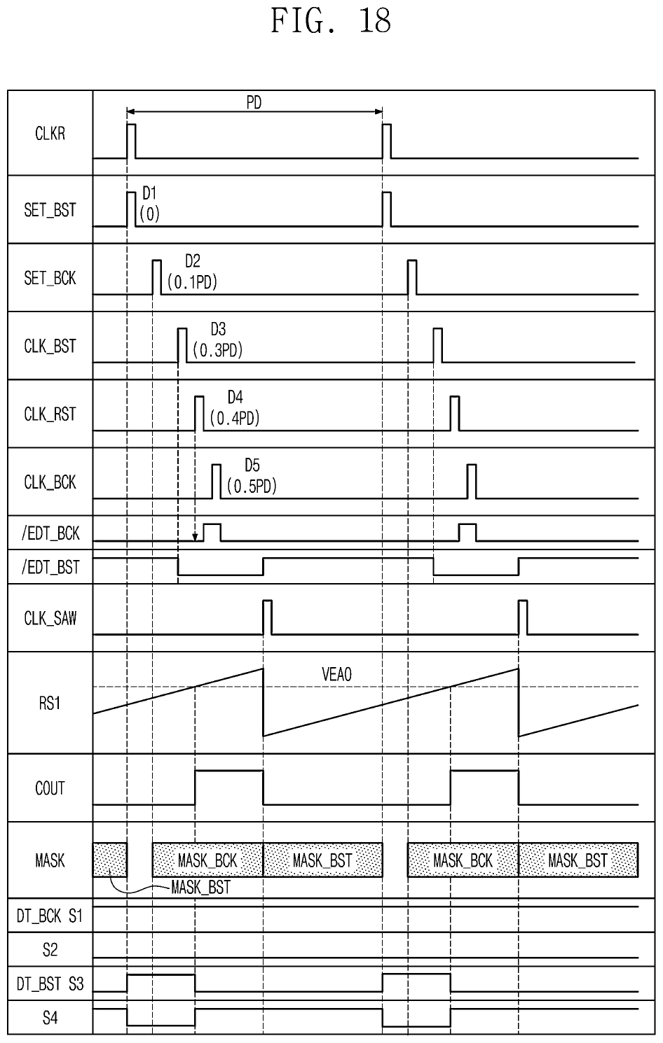

FIG. 18 illustrates a third example of signals of the first regulator 110 according to an embodiment of the present disclosure. In an embodiment, an example in which when the first regulator 110 performs boost conversion, signals of the first regulator 110 change over time is illustrated in FIG. 18.

The reference clock signal CLKR, the set boost signal SET_BST, the set buck signal SET_BCK, the boost clock signal CLK_BST, the reset clock signal CLK_RST, and the buck clock signal CLK_BCK may toggle at timings the same as the timings of FIGS. 12 and 15 and may maintain cycles the same as the cycles of FIGS. 12 and 15.

Because the inverted emulated buck duty signal/EDT_BCK is at the low level at the rising edge of the reset clock signal CLK_RST, the saw clock signal CLK_SAW may toggle in synchronization with the rising edge of the inverted emulated boost duty signal/EDT_BST under control of the mode range controller 240. That is, the first ramp signal RS1 may be reset in synchronization with the rising edge of the inverted emulated boost duty signal/EDT_BST.

In the boost conversion of the first mode, the first signal S1 (or the buck duty signal DT_BCK) may transition to the high level in synchronization with the rising edge of the set buck signal SET_BCK. When the comparison signal COUT transitions from the low level to the high level, the buck mask signal MASK_BCK may be in an active state. Accordingly, the first signal S1 (or the buck duty signal DT_BCK) may maintain the high level. The second signal S2 may be an inverted signal of the first signal S1 (or the buck duty signal DT_BCK). In the boost conversion of the first mode, the second signal S2 may maintain the low level.

In the boost conversion of the first mode, the fourth signal S4 may transition from the high level to the low level in synchronization with the rising edge of the set boost signal SET_BST. When the comparison signal COUT transitions from the low level to the high level, the boost mask signal MASK_BST may be in an inactive state. Accordingly, when the comparison signal COUT transitions from the low level to the high level, the fourth signal S4 may transition from the low level to the high level. The third signal S3 (or the boost duty signal DT_BST) may be an inverted signal of the fourth signal S4.

In the boost conversion of the first mode, the start timing of the charging interval of the first cycle determined by the charging interval and the discharging interval may correspond to the rising edge of the set boost signal SET_BST, at which the third signal S3 (or the boost duty signal DT_BST) transitions from the low level to the high level. In the boost conversion of the first mode, the end timing of the charging interval of the first cycle or the start timing of the discharging interval of the first cycle may correspond to the rising edge of the comparison signal COUT. In the boost conversion of the first mode, the end timing of the discharging interval of the first cycle may correspond to the rising edge of the set boost signal SET_BST. In the boost conversion of the first mode, the second cycle of the first ramp signal RS1 may be synchronized with the saw clock signal CLK_SAW.

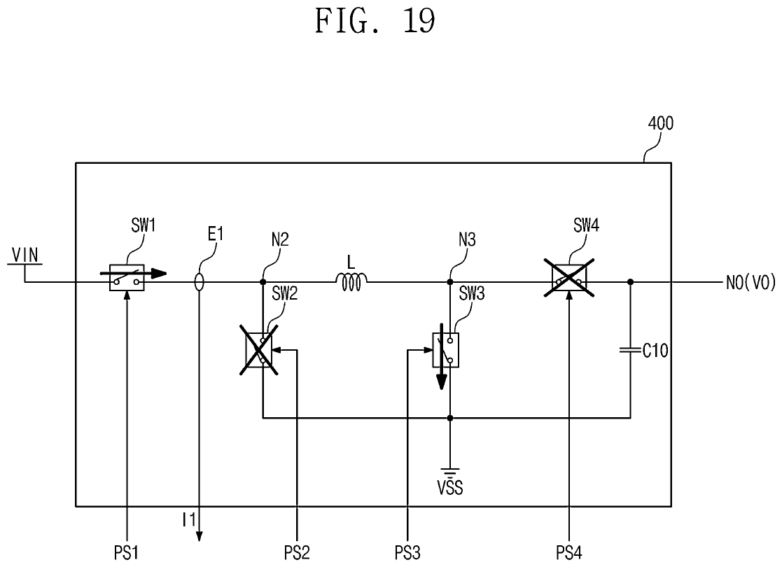

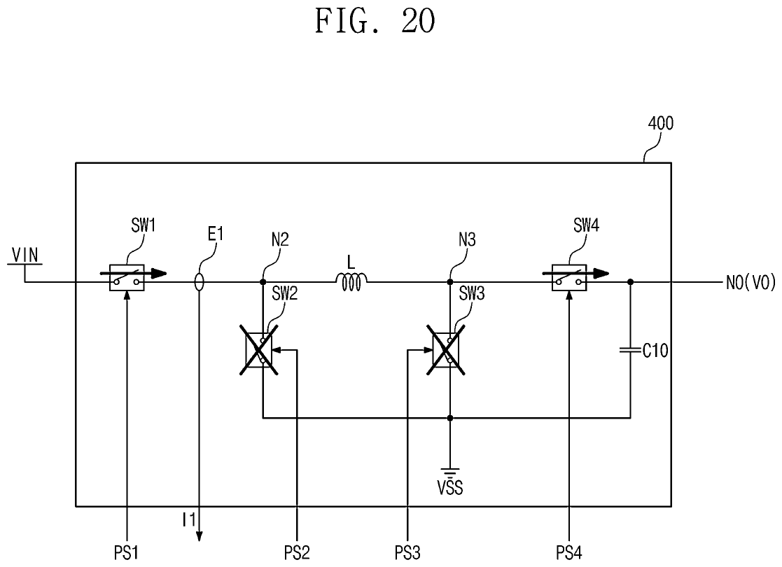

FIG. 19 illustrates an example in which the voltage converter 111 controls the first switch SW1, the second switch SW2, the third switch SW3, and the fourth switch SW4 in the charging interval of the boost conversion manner of the first mode.

Referring to FIG. 19, in the charging interval of the boost conversion manner, the controller 113 may turn on the first switch SW1, may turn off the second switch SW2, may turn on the third switch SW3, and may turn off the fourth switch SW4.

The input voltage VIN may be connected to an electrical path including the first switch SW1, the inductor L, and the ground node to which the ground voltage VSS is applied and may charge the inductor L.

FIG. 20 illustrates an example in which the voltage conversion device 100 (e.g., the voltage converter 400 therein) controls the first switch SW1, the second switch SW2, the third switch SW3, and the fourth switch SW4 in the discharging interval of the buck conversion manner.

Referring to FIG. 20, in the discharging interval of the boost conversion manner, the controller 113 may turn on the first switch SW1, may turn off the second switch SW2, may turn off the third switch SW3, and may turn on the fourth switch SW4.

The inductor L and the tenth capacitor C10 may be connected between the input node and the ground node. The input voltage VIN and the charges stored in the inductor L may charge the tenth capacitor C10 and may be output as the output voltage VO. That is, a sum of the input voltage VIN and the charged voltage of the inductor L and the tenth capacitor C10 may be provided as the output voltage VO.

In an embodiment, the second mode in which the second regulator 120 of the voltage conversion device 100 described with reference to FIGS. 1 to 20 operates may be a low-power mode. For example, the voltage conversion device 100 may be a mobile device such as a smartphone or a smart pad, and the voltage conversion device 100 may receive a voltage of a battery of the mobile device and may supply the output voltage VO to a display device. The second mode may be the low-power mode in which the mobile device only displays simplified information, such as a time and a date, without displaying an image in the whole screen of the display device. The first mode may be a normal power mode in which the mobile device displays an image in the whole screen of the display device, and the normal power mode and the low-power mode may be conceptually opposite to each other.

In the low-power mode where the change in power consumption is relatively small, the second regulator 120 may supply the output voltage VO to the display device in the linear regulation manner. In the normal power mode where the change in power consumption is relatively great, the first regulator 110 may supply the output voltage VO to the display device in the switching regulation manner.

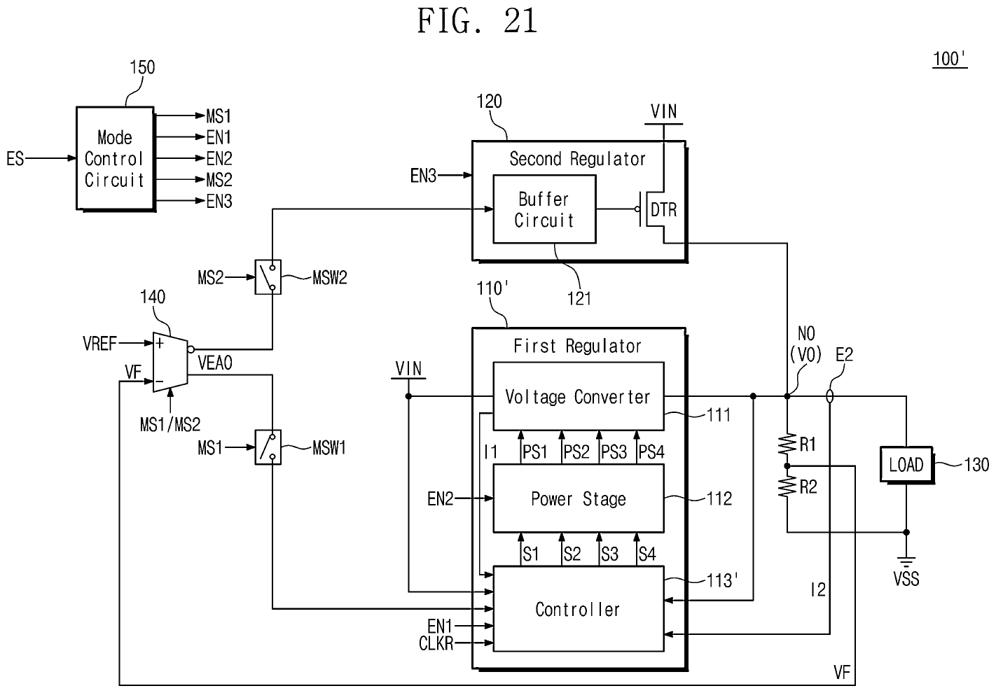

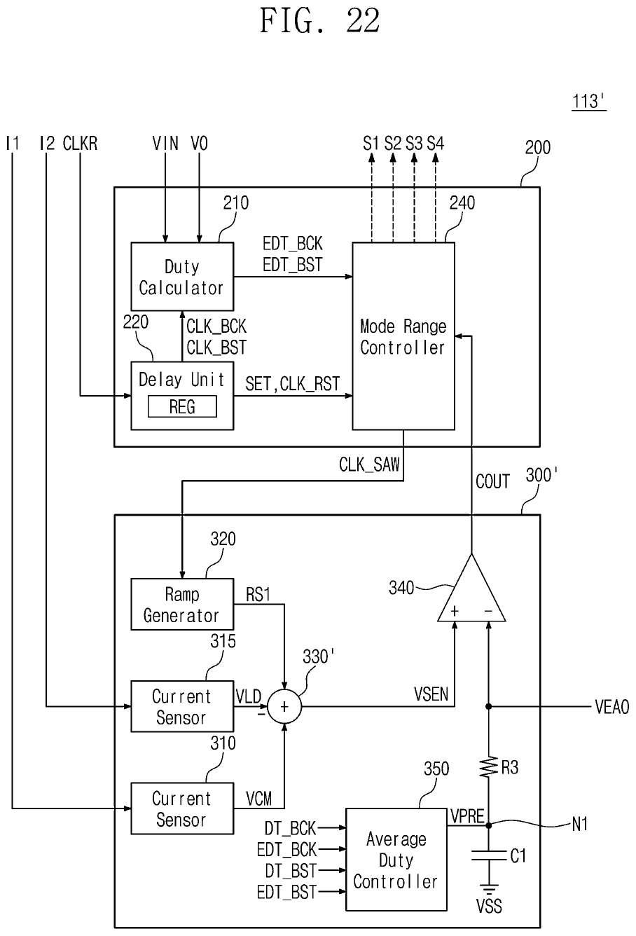

FIG. 21 illustrates a voltage conversion device 100′ according to another embodiment of the present disclosure. Referring to FIG. 21, the voltage conversion device 100′ may include a first regulator 110′, the second regulator 120, the error amplifier 140, the mode control circuit 150, the first resistor R1, the second resistor R2, the first mode switch MSW1, and the second mode switch MSW2.

The first regulator 110′ may include the voltage converter 111, the power stage 112, and a controller 113′. The voltage converter 111 may operate in response to the first power signal PS1, the second power signal PS2, the third power signal PS3, and the fourth power signal PS4. A configuration and an operation of the voltage converter 111 may be the same as those of the voltage converter 111 described with reference to FIGS. 1 to 20. Thus, additional description will be omitted to avoid redundancy.

The power stage 112 may generate the first power signal PS1, the second power signal PS2, the third power signal PS3, and the fourth power signal PS4 in response to the first signal S1, the second signal S2, the third signal S3, and the fourth signal S4. A configuration and an operation of the power stage 112 may be the same as those of the power stage 112 described with reference to FIGS. 1 to 20. Thus, additional description will be omitted to avoid redundancy.

The second regulator 120 may include the buffer circuit 121 and the driving transistor DTR. A configuration and an operation of the second regulator 120 may be the same as those of the second regulator 120 described with reference to FIGS. 1 to 20. Thus, additional description will be omitted to avoid redundancy.

Configurations and operations of the error amplifier 140, the mode control circuit 150, the first mode switch MSW1, the second mode switch MSW2, the first resistor R1, the second resistor R2, and the load 130 may be the same as those of the error amplifier 140, the mode control circuit 150, the first mode switch MSW1, the second mode switch MSW2, the first resistor R1, the second resistor R2, and the load 130 described with reference to FIGS. 1 to 20. Thus, additional description will be omitted to avoid redundancy.

Compared to the voltage conversion device 100 described with reference to FIGS. 1 to 20, the voltage conversion device 100′ may further include a second current extractor E2. The second current extractor E2 may extract information of a current flowing to the load 130, that is, second current information 12. The second current information 12 may be transferred to the controller 113′. The second current information 12 may correspond to a current or a voltage having a level indicating a current amount.

The controller 113′ may preset the switching timings and the error voltage VEAO further based on the second current information 12 in addition to the input voltage VIN, the output voltage VO, the error voltage VEAO, and the first current information I1.

FIG. 22 illustrates the controller 113′ according to another embodiment of the present disclosure. Referring to FIGS. 20 and 21, the controller 113′ may include the control circuit 200 and a comparison circuit 300′. The control circuit 200 may include the duty calculator 210, the delay unit 220, and the mode range controller 240. A configuration and an operation of the control circuit 200 may be the same as those of the control circuit 200 described with reference to FIGS. 1 to 20. Thus, additional description will be omitted to avoid redundancy.

The comparison circuit 300′ may include the current sensor 310, a current sensor 315, the ramp generator 320, an adder 330′, the first comparator 340, the average duty controller 350, the first capacitor C1, and the third resistor R3. Configurations and operations of the current sensor 310, the ramp generator 320, the first comparator 340, the average duty controller 350, the first capacitor C1, and the third resistor R3 may be the same as those of the current sensor 310, the ramp generator 320, the first comparator 340, the average duty controller 350, the first capacitor C1, and the third resistor R3 described with reference to FIGS. 1 to 20. Thus, additional description will be omitted to avoid redundancy.

Compared to the comparison circuit 300 described with reference to FIGS. 1 to 20, the comparison circuit 300′ may further include the current sensor 315. The current sensor 315 may receive the second current information 12. The current sensor 315 may output, as a load current information voltage VLD, a voltage corresponding to a current amount which the second current information 12 indicates.

The adder 330′ may subtract the load current information voltage VLD from a voltage obtained by adding the first ramp signal RS1 and the current information voltage VCM. That is, the voltage conversion device 100′ may perform the preset operation in consideration of power consumption of the load 130. Also, the voltage conversion device 100′ may convert the input voltage VIN into the output voltage VO in consideration of power consumption of the load 130.

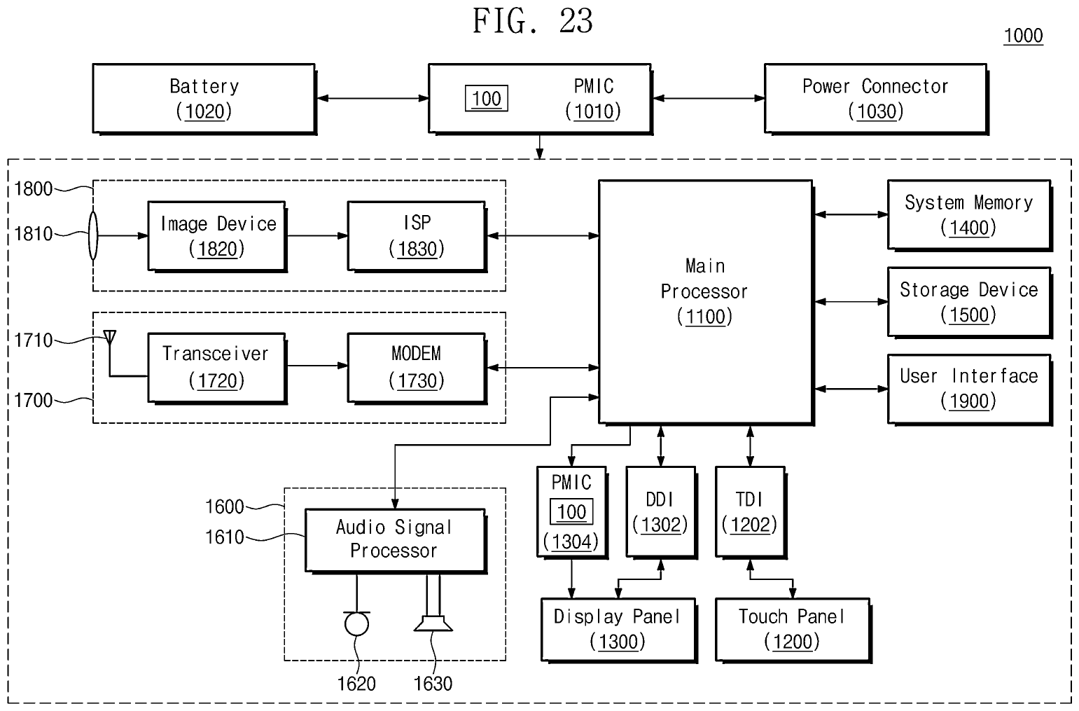

FIG. 23 is a diagram illustrating an electronic device 1000 including the voltage conversion device 100 or 100′ according to an embodiment of the present disclosure. Referring to FIG. 23, the electronic device 1000 may include a main processor 1100, a touch panel 1200, a touch driver integrated circuit (TDI) 1202, a display panel 1300, a display driver integrated circuit (DDI) 1302, a system memory 1400, a storage device 1500, an audio processor 1600, a communication block 1700, an image processor 1800, and a user interface 1900. In an embodiment, the electronic device 1000 may be one of various electronic devices such as a personal computer, a laptop computer, a server, a workstation, a portable communication terminal, a personal digital assistant (PDA), a portable media player (PMP), a digital camera, a smartphone, a tablet computer, and a wearable device.

The main processor 1100 may control an overall operation of the electronic device 1000. The main processor 1100 may control/manage operations of the components of the electronic device 1000. The main processor 1100 may perform various operations to operate the electronic device 1000. The touch panel 1200 may be configured to sense a touch input from a user under control of the touch driver integrated circuit 1202. The display panel 1300 may be configured to display image information under control of the display driver integrated circuit 1302.

The system memory 1400 may store data which are used in the operation of the electronic device 1000. For example, the system memory 1400 may include a volatile memory such as a static random access memory (SRAM), a dynamic RAM (DRAM), or a synchronous DRAM (SDRAM), and/or a nonvolatile memory such as a phase change RAM (PRAM), a magneto-resistive RAM (MRAM), a resistive RAM (ReRAM), or a ferroelectric RAM (FRAM).

The storage device 1500 may store data regardless of whether a power is supplied. For example, the storage device 1500 may include at least one of various nonvolatile memories such as a flash memory, a PRAM, an MRAM, a ReRAM, and a FRAM. For example, the storage device 1500 may include an embedded memory and/or a removable memory of the electronic device 1000.

The audio processor 1600 may process an audio signal by using an audio signal processor 1610. The audio processor 1600 may receive an audio input through a microphone 1620 or may provide an audio output through a speaker 1630. The communication block 1700 may exchange signals with an external device/system through an antenna 1710. A transceiver 1720 and a modulator/demodulator (MODEM) 1730 of the communication block 1700 may process signals exchanged with the external device/system, based on at least one of various wireless communication protocols: long term evolution (LTE), worldwide interoperability for microwave access (WiMax), global system for mobile communication (GSM), code division multiple access (CDMA), Bluetooth, near field communication (NFC), wireless fidelity (Wi-Fi), and radio frequency identification (RFID).

The image processor 1800 may receive a light through a lens 1810. An image device 1820 and an image signal processor (ISP) 1830 included in the image processor 1800 may generate image information about an external object, based on a received light. The user interface 1900 may include an interface capable of exchange information with a user, except for the touch panel 1200, the display panel 1300, the audio processor 1600, and the image processor 1800. The user interface 1900 may include a keyboard, a mouse, a printer, a projector, various sensors, a human body communication device, etc.

The electronic device 1000 may further include a power management IC (PMIC) 1010, a battery 1020, and a power connector 1030. The power management IC 1010 may generate an internal power from a power supplied from the battery 1020 or a power supplied from the power connector 1030, and may provide the internal power to the main processor 1100, the touch panel 1200, the touch driver integrated circuit (TDI) 1202, the display panel 1300, the display driver integrated circuit (DDI) 1302, the system memory 1400, the storage device 1500, the audio processor 1600, the communication block 1700, the image processor 1800, and the user interface 1900. The power management IC 1010 may include the voltage conversion device 100 or 100′ according to an embodiment of the present disclosure. The voltage conversion device 100 or 100′ may perform switching voltage conversion by using the first regulator 110 or 110′ in the first mode and may perform linear voltage conversion by using the second regulator 120 in the second mode. When the transition from the second mode to the first mode is made, the first regulator 110 or 110′ of the voltage conversion device 100 or 100′ may preset the switching timings and the error voltage VEAO.

The electronic device 1000 may further include a display power management integrated circuit 1304. The display power management integrated circuit 1304 may manage the power which is supplied to the display panel 1300. The display power management IC 1304 may include the voltage conversion device 100 or 100′ according to an embodiment of the present disclosure. The voltage conversion device 100 or 100′ may perform switching voltage conversion by using the first regulator 110 or 110′ in the first mode and may perform linear voltage conversion by using the second regulator 120 in the second mode. When the transition from the second mode to the first mode is made, the first regulator 110 or 110′ of the voltage conversion device 100 or 100′ may preset the switching timings and the error voltage VEAO.

In the above embodiments, components according to the present disclosure are described by using the terms “first”, “second”, “third”, etc. However, the terms “first”, “second”, “third”, etc. may be used to distinguish components from each other and do not limit the present disclosure. For example, the terms “first”, “second”, “third”, etc. do not involve an order or a numerical meaning of any form.

In the above embodiments, components according to embodiments of the present disclosure are referenced by using blocks. The blocks may be implemented with various hardware devices, such as an integrated circuit, an application specific IC (ASIC), a field programmable gate array (FPGA), and a complex programmable logic device (CPLD), firmware driven in hardware devices, software such as an application, or a combination of a hardware device and software. Also, the blocks may include circuits implemented with semiconductor elements in an integrated circuit, or circuits enrolled as an intellectual property (IP).

According to embodiments of the present disclosure, a voltage converter capable of improving voltage conversion efficiency through a linear voltage conversion mode and a switching voltage conversion mode and an operating method of the voltage converter are provided. Also, according to embodiments of the present disclosure, a voltage converter capable of reducing the area through a structure in which a linear regulator and a switching regulator share an error amplifier and an operating method of the voltage converter are provided. Also, according to embodiments of the present disclosure, a voltage converter capable of reducing a ripple through a scheme in which an error voltage and switching timings are preset when the transition from the linear voltage conversion mode to the switching voltage conversion mode and an operating method of the voltage converter are provided.

While the present disclosure has been described with reference to embodiments thereof, it will be apparent to those of ordinary skill in the art that various changes and modifications may be made thereto without departing from the scope of the present disclosure as set forth in the following claims.

What is claimed is:

1. A voltage conversion device comprising:
a first regulator configured to convert an input voltage of an input node into a first output voltage in a first mode and to provide the first output voltage to an output node;
a second regulator configured to convert the input voltage of the input node into a second output voltage in a second mode and to provide the second output voltage to the output node;
a first resistor and a second resistor connected in series between the output node and a ground node; and
an error amplifier configured to receive a feedback voltage of a node between the first resistor and the second resistor and a reference voltage, to amplify a difference between the feedback voltage and the reference voltage to generate an error voltage, to provide the error voltage to the first regulator in the first mode, and to provide the error voltage to the second regulator in the second mode.

2. The voltage conversion device of claim 1,
wherein, in the first mode, the error amplifier is configured to amplify a value obtained by subtracting the feedback voltage from the reference voltage to generate the error voltage, and
wherein, in the second mode, the error amplifier is configured to amplify the value obtained by subtracting the feedback voltage from the reference voltage and to invert the amplified value to generate the error voltage.

3. The voltage conversion device of claim 1, further comprising:
a first switch configured to transfer the error voltage to the first regulator in the first mode and to block the error voltage from being transferred to the first regulator in the second mode; and
a second switch configured to transfer the error voltage to the second regulator in the second mode and to block the error voltage from being transferred to the second regulator in the first mode.

4. The voltage conversion device of claim 1,
wherein the first regulator includes a switching regulator, and
wherein the second regulator includes a linear regulator.

5. The voltage conversion device of claim 1, wherein the first regulator includes:
a voltage converter connected to the input node and the output node and including a plurality of switches, at least one inductor, and at least one capacitor;
a control circuit configured to generate control signals corresponding to the plurality of switches such that the input voltage of the input node is converted into the first output voltage, the first output voltage being transferred to the output node; and
a power stage configured to control the plurality of switches based on the control signals.

6. The voltage conversion device of claim 5, wherein, when a transition from the second mode to the first mode is made, the control circuit is configured to preset the error voltage and switching timings of the control signals based on the error voltage, the input voltage, and the first output voltage.

7. The voltage conversion device of claim 6, wherein, in the second mode, the control circuit and the power stage are configured to be powered off.

8. The voltage conversion device of claim 6, wherein, while the control circuit presets the error voltage and the switching timings of the control signals, the power stage and the voltage converter are configured to maintain a power-off state.

9. The voltage conversion device of claim 8, wherein, after the control circuit presets the error voltage and the switching timings of the control signals, the power stage is configured to be powered on to control the voltage converter.

10. The voltage conversion device of claim 6, wherein, in the first mode, the control circuit is configured to:
generate emulated duty signals based on the input voltage and the first output voltage;
control a ramp signal based on the emulated duty signals; and
control the switching timings of the control signals based on the error voltage and the ramp signal.

11. The voltage conversion device of claim 6, wherein the control circuit is configured to preset the error voltage and the switching timings of the control signals based on negative feedback.

12. The voltage conversion device of claim 5, wherein, in the first mode, the control circuit is configured to:
generate emulated duty signals based on the input voltage and the first output voltage;
control a ramp signal based on the emulated duty signals; and
control switching timings of the control signals based on the error voltage and the ramp signal,
wherein the emulated duty signals include an emulated buck duty signal and an emulated boost duty signal, and
wherein the control signals include a buck duty signal and a boost duty signal.

13. The voltage conversion device of claim 12, wherein, in the first mode, the control circuit is configured to perform buck conversion by adjusting a reset timing of the ramp signal based on the emulated buck duty signal.

14. The voltage conversion device of claim 12, wherein, in the first mode, the control circuit is configured to perform buck-boost conversion or boost conversion by adjusting a reset timing of the ramp signal based on the emulated boost duty signal.

15. The voltage conversion device of claim 12, wherein, in the first mode, the control circuit is configured to perform buck conversion when a duty of an inverted signal of the emulated buck duty signal is longer than a threshold value.

16. The voltage conversion device of claim 12, wherein, in the first mode, the control circuit is configured to perform buck-boost conversion or boost conversion when a duty of an inverted signal of the emulated buck duty signal is shorter than or equal to a threshold value.

17. A voltage conversion device comprising:
a first regulator configured to convert an input voltage of an input node into a first output voltage in a first mode and to provide the first output voltage to an output node; and
a second regulator configured to convert the input voltage of the input node into a second output voltage in a second mode and to provide the second output voltage to the output node,
wherein the first regulator includes:
a voltage converter connected to the input node and the output node and including a plurality of switches, at least one inductor, and at least one capacitor;
a control circuit configured to generate control signals corresponding to the plurality of switches such that the input voltage of the input node is converted into the first output voltage, the first output voltage being transferred to the output node; and
a power stage configured to control the plurality of switches based on the control signals, and
wherein, in the first mode, the control circuit is configured to:
generate emulated duty signals based on the input voltage and the first output voltage;
control a ramp signal based on the emulated duty signals; and
control switching timings of the control signals based on an error voltage and the ramp signal.

18. The voltage conversion device of claim 17, wherein, when a transition from the second mode to the first mode is made, the control circuit is configured to preset the error voltage and the switching timings of the control signals based on the error voltage, the input voltage, and the first output voltage.

19. The voltage conversion device of claim 17, further comprising:
a first resistor and a second resistor connected in series between the output node and a ground node; and
an error amplifier configured to receive a feedback voltage of a node between the first resistor and the second resistor and a reference voltage, to amplify a difference between the feedback voltage and the reference voltage to generate the error voltage, to provide the error voltage to the first regulator in the first mode, and to provide the error voltage to the second regulator in the second mode,
wherein the first regulator and the second regulator are both switchably coupled between the error amplifier and the output node.

20. An operating method of a voltage conversion device that includes a switching regulator and a linear regulator, the method comprising:
converting an input voltage into an output voltage by using the switching regulator, in a first mode;
when a transition from the first mode to a second mode is made, converting the input voltage into the output voltage by using the linear regulator; and
when a transition from the second mode to the first mode is made, presetting switching timings of the switching regulator and an error voltage while the output voltage is not provided by the switching regulator and is not provided by the linear regulator,
wherein an error amplifier providing the error voltage is shared by the switching regulator and the linear regulator.
